(19) United States
(12) Patent Application Publication
(10) Pub. No.: US 2023/0359459 A1
(43) Pub. Date: Nov. 9, 2023

(54) CONTROL METHOD, DEVICE, AND RECORDING MEDIUM

(71) Applicant: Panasonic Intellectual Property Corporation of America, Torrance, CA (US)

(72) Inventors: Ayaka MITANI, Osaka (JP); Naohisa NISHIDA, Osaka (JP); Yuuki HIROSE, Osaka (JP); Junji MICHIYAMA, Fukuoka (JP)

(21) Appl. No.: 18/224,129

(22) Filed: Jul. 20, 2023

Related U.S. Application Data
(63) Continuation of application No. PCT/JP2022/002569, filed on Jan. 25, 2022.
(60) Provisional application No. 63/143,274, filed on Jan. 29, 2021.

(51) Int. Cl. G06F 8/71; G06Q 20/40

(52) U.S. Cl. CPC G06F 8/71; G06Q 20/401

(57) ABSTRACT

A control method that is performed by a device in a distributed ledger system including a plurality of nodes each holding a distributed ledger includes: obtaining transaction data to be stored into the distributed ledger; obtaining a security level of each of the plurality of nodes; and preferentially determining a node having a higher security level among the plurality of nodes as a destination node for the transaction data.

### CROSS REFERENCE TO RELATED APPLICATIONS

This is a continuation application of PCT International Application No. PCT/JP2022/002569 filed on Jan. 25, 2022, designating the United States of America, which is based on and claims priority of U.S. Provisional Patent Application No. 63/143,274 filed on Jan. 29, 2021. The entire disclosures of the above-identified applications, including the specifications, drawings and claims are incorporated herein by reference in their entirety.

### FIELD

The present disclosure relates to control methods, devices, and recording media.

### BACKGROUND

One conventional example of a consensus algorithm by which an agreement about transaction data is made in a peer-to-peer (P2P) network that manages a distributed ledger is proof of work (PoW) (refer to Patent Literature (PTL) 1).

### CITATION LIST

### Patent Literature

PTL 1: Japanese Unexamined Patent Application Publication No. 2018-147016

### SUMMARY

### Technical Problem

However, there are cases where the reliability of transaction data that is stored into a distributed ledger may be decreased, which is problematic.

Thus, the present disclosure provides a control method, etc., in which the decrease in the reliability of transaction data that is stored into a distributed ledger is minimized.

### Solution to Problem

A control method according to one aspect of the present disclosure is a control method that is performed by a device in a distributed ledger system including a plurality of nodes each holding a distributed ledger, and includes: obtaining transaction data to be stored into the distributed ledger; obtaining a security level of each of the plurality of nodes; and determining, preferentially, a node having a higher security level among the plurality of nodes as a destination node for the transaction data.

Note that these general and specific aspects may be implemented using a system, a device, an integrated circuit, a computer program, or a computer-readable recording medium such as compact disc read-only memory (CD-ROM), or any combination of systems, devices, integrated circuits, computer programs, or recording media.

### Advantageous Effects

With the control method according to the present disclosure, it is possible to minimize the decrease in the reliability of transaction data that is stored into a distributed ledger.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram schematically illustrating a system according to Embodiment 1.

FIG. 2 is a block diagram schematically illustrating functions of a control device according to Embodiment 1.

FIG. 3 is a flowchart illustrating processes performed by a control device according to Embodiment 1.

FIG. 4 is a block diagram schematically illustrating functions of a control device according to Embodiment 2.

FIG. 5 is a block diagram schematically illustrating functions of a node according to Embodiment 2.

FIG. 6 is a block diagram schematically illustrating functions of a distribution server according to Embodiment 2.

FIG. 7 is a block diagram schematically illustrating functions of a terminal according to Embodiment 2.

FIG. 8 is an explanatory diagram illustrating a first example of version information according to Embodiment 2.

FIG. 9 is an explanatory diagram illustrating a second example of version information according to Embodiment 2.

FIG. 10 is a flowchart illustrating processes performed by a control device according to Embodiment 2.

FIG. 11 is a first sequence chart illustrating processes performed by a system according to Embodiment 2.

FIG. 12 is a second sequence chart illustrating processes performed by a system according to Embodiment 2.

FIG. 13 is a third sequence chart illustrating processes performed by a system according to Embodiment 2.

FIG. 14 is a block diagram schematically illustrating functions of a control device according to Embodiment 3.

FIG. 15 is an explanatory diagram illustrating a first example of specifying information according to Embodiment 3.

FIG. 16 is an explanatory diagram illustrating a second example of specifying information according to Embodiment 3.

FIG. 17 is a flowchart illustrating processes performed by a control device according to Embodiment 3.

FIG. 18 is a block diagram schematically illustrating a system according to Embodiment 4.

FIG. 19 is a block diagram schematically illustrating functions of a distribution server according to Embodiment 4.

FIG. 20 is a block diagram schematically illustrating functions of a terminal according to Embodiment 4.

FIG. 21 is a sequence chart illustrating processes performed by a system according to Embodiment 4.

FIG. 22 is a block diagram schematically illustrating functions of a node according to Embodiment 5.

FIG. 23 is a flowchart illustrating processes performed by a node according to Embodiment 5.

FIG. 24 is a first sequence chart illustrating processes performed by a system according to Embodiment 5.

FIG. 25 is a second sequence chart illustrating processes performed by a system according to Embodiment 5.

FIG. 26 is an explanatory diagram illustrating the data structure of a blockchain.

FIG. 27 is an explanatory diagram illustrating the data structure of transaction data.

### DESCRIPTION OF EMBODIMENTS

### (Underlying Knowledge Forming Basis of the Present Disclosure)

The inventors of the present application have found that the following problem occurs with the technique related to a distributed ledger that has been described in the “Background” section.

Devices with various specifications can be used as a plurality of devices (also referred to as nodes) included in a system that is a P2P network that manages a distributed ledger. The plurality of devices may have different software products (operating systems (OSs), application software products, driver software products, etc.) installed therein, may have different hardware products mounted thereon, or may have different versions thereof, for example.

The plurality of devices may include a device with a relatively low security level. The security level is an index indicating how secure a computer is.

When a device with a relatively low security level is included, a trouble may occur in executing a consensus algorithm that is executed among the plurality of devices. The device with a relatively low security level is, for example, a device having a malfunctioning software product or a vulnerable software product installed therein.

Note that more advanced versions of software products generally tend to have less malfunctions or be less (or no longer) vulnerable; thus, it can be said that a device including a software product whose version is significantly different from the latest version of said software product is a device with a relatively low security level.

In this case, a problem may occur with the compatibility of transaction data that is stored into a distributed ledger, which may result in a decrease in the reliability of the transaction data that is stored into the distributed ledger.

In order solve this problem, a control method according to one aspect of the present disclosure is a control method that is performed by a control device (also referred to as a device) in a distributed ledger system including a plurality of nodes each holding a distributed ledger, and includes: obtaining transaction data to be stored into the distributed ledger; obtaining a security level of each of the plurality of nodes; and determining, preferentially, a node having a higher security level among the plurality of nodes as a destination node for the transaction data.

According to this aspect, a node having a relatively high security level among the plurality of nodes is determined as a destination node for the transaction data, and thus the control device contributes to the transaction data being stored into the distributed ledger by the process performed by the node having a relatively high security level. If the transaction data is stored into the distributed ledger by the process performed by a node having a low security level, the reliability of the transaction data that is stored into the distributed ledger is decreased when said process has some flaws. In this manner, with the above-described control method, it is possible to minimize the decrease in the reliability of the transaction data that is stored into the distributed ledger.

For example, the determining may include: determining, from among the plurality of nodes, an authorized node that is authorized to determine whether to store the transaction data into the distributed ledger; and determining, preferentially, the authorized node determined, as the destination node.

According to this aspect, the control device preferentially determines the authorized node among the plurality of nodes as the destination node; thus, it is possible to store the transaction data into the distributed ledger after the authorized node that has received the transaction data determines whether to store the transaction data into the distributed ledger. This makes information processing easier than when another node is determined as the destination node, meaning that it is possible to contribute to reduced network congestion and a reduction in power consumption, as a result of a reduction in the amount of computer processing required, thereby providing improvements in computer-functionality. Additionally, with the above-described control method, it is possible to more easily minimize the decrease in the reliability of the transaction data that is stored into the distributed ledger.

For example, the control method may further include: obtaining version information indicating a version of a software product included in each of the plurality of nodes, and in the obtaining of the security level, the security level may be obtained by setting a security level of a node including a newer version of the software product to a higher security level based on the version information obtained.

According to this aspect, the control device can easily set the security level using information indicating how old the version of the software product included in each of the plurality of nodes is and can determine the destination node using the security level that has been set in this manner. Thus, with the above-described control method, it is possible to more easily minimize the decrease in the reliability of the transaction data that is stored into the distributed ledger.

In the obtaining of the security level, the security level may be obtained by setting a security level of a node having a smaller version difference among the plurality of nodes to a higher security level based on the version information obtained, the smaller version difference indicating that a difference between the version of the software product included in the node and a latest version available for the node is smaller.

According to this aspect, the control device can easily set the security level using the difference between the version of the software product included in each of the plurality of nodes and the latest version of said software product and can determine the destination node using the security level that has been set in this manner. Thus, with the above-described control method, it is possible to more easily minimize the decrease in the reliability of the transaction data that is stored into the distributed ledger.

The control method may further include: obtaining version information indicating a version of a software product included in each of the plurality of nodes, and in the obtaining of the security level, the security level may be obtained by setting a security level of a node including a specific version of the software product to a lower security level based on the version information obtained.

According to this aspect, the control device can easily set the security level on the basis of whether the version of the software product included in each of the plurality of nodes is a specific version and can determine the destination node using the security level that has been set in this manner. Thus, with the above-described control method, it is possible to more easily minimize the decrease in the reliability of the transaction data that is stored into the distributed ledger.

For example, the plurality of nodes may include, as the software product, two software products that are an operating system and driver software. In the obtaining of the version information, first version information indicating a version of the operating system and second version information indicating a version of the driver software may be obtained, and in the obtaining of the security level, the security level may be obtained by setting a security level of a node including a specific set of the version of the operating system and the version of the driver software to a lower security level based on the first version information and the second version information.

According to this aspect, the control device can easily set the security level on the basis of whether the version set of the operating system and the application software product included in each of the plurality of nodes is a specific set and can determine the destination node using the security level that has been set in this manner. Thus, with the above-described control method, it is possible to more easily minimize the decrease in the reliability of the transaction data that is stored into the distributed ledger.

The distributed ledger may be a first distributed ledger. The distributed ledger system may further include a plurality of servers each holding a second distributed ledger and including a function for distributing the software product that is included in each of the plurality of nodes. The second distributed ledger is a distributed ledger in which the version of the software product distributed to each of the plurality of nodes is managed. In the obtaining of the version information, the version information may be obtained by referring to the second distributed ledger managed by each of the plurality of servers.

According to this aspect, the control device can obtain the security level using the version information obtained with reference to the distributed ledger for software version management that is managed by the plurality of servers that distribute the software product and can determine the destination node. Since the version information that is properly managed by the distributed ledger in a practically tamper-free manner is used, a more appropriate node can be determined as the destination node. Thus, with the above-described control method, it is possible to more properly minimize the decrease in the reliability of the transaction data that is stored into the distributed ledger.

The distributed ledger may be a first distributed ledger, each of the plurality of nodes may include a third distributed ledger in which the security level of each of the plurality of nodes is managed, and in the obtaining of the security level, the security level may be obtained by reading the security level from the third distributed ledger.

According to this aspect, the control device can obtain the security level using the version information obtained with reference to the distributed ledger for software version management that is managed by the plurality of nodes themselves and can determine the destination node. Since the version information that is properly managed by the distributed ledger in a practically tamper-free manner is used, a more appropriate node can be determined as the destination node. Thus, with the above-described control method, it is possible to more properly minimize the decrease in the reliability of the transaction data that is stored into the distributed ledger.

For example, in the determining, among the plurality of nodes, a node having a security level greater than or equal to a threshold value may be determined as the destination node.

According to this aspect, the control device preferentially determines a node having a higher security level, specifically, a node having a security level greater than or equal to the threshold value, as the destination node. With this, it is possible to easily determine which node is to be determined as the destination node. Thus, with the above-described control method, it is possible to more easily minimize the decrease in the reliability of the transaction data that is stored into the distributed ledger.

The determining, among the plurality of nodes, a randomly selected node having a security level greater than or equal to a threshold value may be determined as the destination node.

According to this aspect, the control device preferentially determines a node having a higher security level, specifically, a randomly selected node having a security level greater than or equal to the threshold value, as the destination node. This makes it possible to more easily determine which node is to be determined as the destination node while keeping specific nodes having relatively high security levels from being disproportionately determined as the destination nodes. Thus, with the above-described control method, it is possible to more easily minimize the decrease in the reliability of the transaction data that is stored into the distributed ledger.

The control method may further include: transmitting, to the destination node determined, the transaction data obtained.

According to this aspect, the control device transmits the transaction data to the node determined as the destination node and having a relatively high security level. This allows the control device to easily perform control such that the transaction data is stored into the distributed ledger by the process performed by the node having a relatively high security level. Thus, with the above-described control method, it is possible to more easily minimize the decrease in the reliability of the transaction data that is stored into the distributed ledger.

Furthermore, a control device according to one aspect of the present disclosure is a control device in a distributed ledger system including a plurality of nodes each holding a distributed ledger, and includes: an obtainer that obtains transaction data to be stored into the distributed ledger and obtains a security level of each of the plurality of nodes; and a determiner that determines, preferentially, a node having a higher security level among the plurality of nodes as a destination node for the transaction data.

According to this aspect, advantageous effects that are substantially the same as those produced by the above-described control method are produced.

Furthermore, a recording medium according to one aspect of the present disclosure is a non-transitory computer-readable recording medium having recorded thereon a program for causing a computer to execute the above-described control method.

According to this aspect, advantageous effects that are substantially the same as those produced by the above-described control method are produced.

Note that these general and specific aspects may be implemented using a system, a device, an integrated circuit, a computer program, or a computer-readable recording medium such as a CD-ROM, or any combination of systems, devices, integrated circuits, computer programs, or recording media.

Hereinafter, exemplary embodiments are described in greater detail with reference to the Drawings.

Note that each of the exemplary embodiments described below shows a general or specific example. The numerical values, shapes, materials, structural elements, the arrangement and connection of the structural elements, steps, the processing order of the steps, etc., shown in the following exemplary embodiments are mere examples, and are not intended to limit the present disclosure. Among the structural elements in the following exemplary embodiments, structural elements not recited in any one of the independent claims which indicate the broadest concepts will be described as optional structural elements.

### Embodiment 1

The present exemplary embodiment will describe a control method, etc., in which the decrease in the reliability of transaction data that is stored into a distributed ledger is minimized.

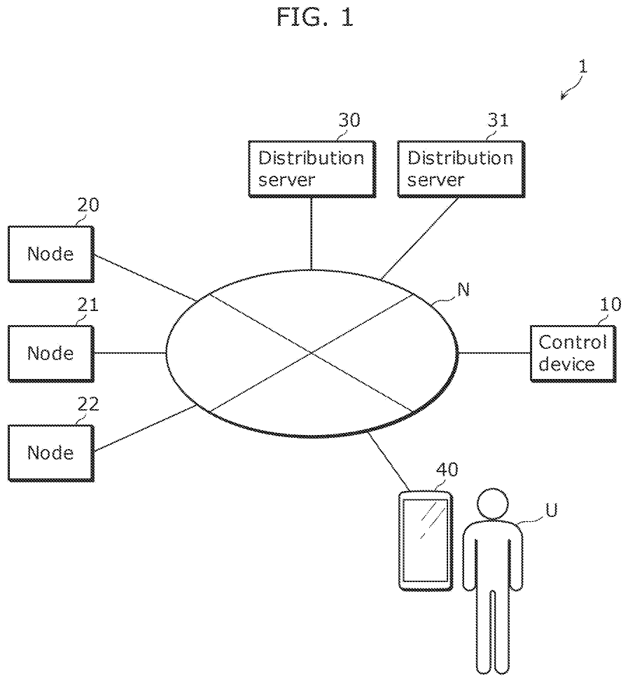

FIG. 1 is a block diagram schematically illustrating system 1 according to the present exemplary embodiment. System 1 corresponds to a distributed ledger system including a plurality of nodes 20, 21, 22 each holding a distributed ledger.

As illustrated in FIG. 1, system 1 includes at least the plurality of nodes 20, 21, 22 (also referred to as node(s) 20, etc.). Furthermore, system 1 includes one or more devices that are control device 10, distribution servers 30, 31 (also referred to as distribution server(s) 30, etc.), and terminal 40. The plurality of nodes 20, etc., and the one or more devices included in system 1 are connected to network N and can communicate with each other via network N. Examples of network N, which may be any communication line or any network, include the Internet and a cell-phone carrier network.

Control device 10 is a device that controls the operation of system 1. Control device 10 controls one or more nodes selected from among the plurality of nodes 20, etc., so that the one or more nodes are authorized to determine whether to store transaction data into the distributed ledger, and thus minimizes the decrease in the reliability of the transaction data that is stored into the distributed ledger. Note that control device 10 may be a device independent of another device or may be provided as a function of one or more devices that are node 20, etc., distribution server 30, etc., and terminal 40.

Node 20, which is one of the plurality of nodes 20, etc., each holding the distributed ledger, is provided as a computer. Node 20 includes a software product that operates on node 20. Transaction data is stored into the distributed ledger held by node 20. The software product may include an operating system (OS), an application software product, a device software product, or the like. The same applies hereinafter.

Each of nodes 21, 22 is a device that has the same functions as node 20 and operates independently of node 20. Note that FIG. 1 illustrates three nodes as an example of node 20, etc., but system 1 may include more nodes. Note that the node may also be called a device, a server, a terminal, or the like.

The software product in each of nodes 21, 22 is independent of the software product in node 20. For example, the software product in node 20, the software product in node 21, and the software product in node 22 may be those manufactured by software manufacturers, namely, company K, company L, and company M, respectively.

Distribution server 30 is a server that distributes, via network N, the software product to be used by node 20 and is provided as a computer. The software product may include a software product that is used by node 20. Distribution server 30 may be operated by company K, for example.

Distribution server 31 is a server that distributes, via network N, the software product to be used by node 21 and is provided as a computer. The software product may include a software product that is used by node 21. Distribution server 31 may be operated by company L, for example.

Terminal 40 is a device that generates transaction data to be stored into the distributed ledger held by system 1. Terminal 40 is a terminal held by user U, for example, and is operated by user U. Terminal 40 transmits the generated transaction data to node 20, etc., via control device 10 so that the transaction data is stored. The transaction data may contain any data that may be, for example, data indicating exchange of value information (such as money and coupons that play a role similar to money) or data indicating an owner of content (for example, digital content).

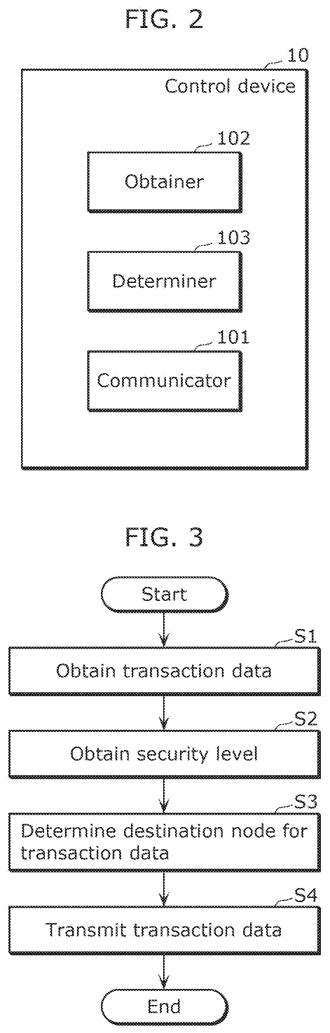

FIG. 2 is a block diagram schematically illustrating the functions of control device 10 according to the present exemplary embodiment.

As illustrated in FIG. 2, control device 10 includes communicator 101, obtainer 102, and determiner 103 as function parts. The function parts included in control device 10 may each be provided by a processor (for example, a central processing unit (CPU) (not illustrated in the Drawings)) executing a predetermined program using memory (not illustrated in the Drawings).

Communicator 101 is a communication interface that can be connected to network N. Communicator 101 may be a communication interface that performs wireless communication using Wi-Fi (registered trademark), a cell-phone network, or the like or a communication interface that performs wired communication using Ethernet (registered trademark) or the like, for example.

Obtainer 102 obtains the transaction data to be stored into the distributed ledger. This transaction data may be transaction data transmitted by terminal 40 as the data to be stored into the distributed ledger. Obtainer 102 may obtain the transaction data via communicator 101.

Furthermore, obtainer 102 obtains the security level of each of the plurality of nodes 20, etc. Obtainer 102 may obtain the security level via communicator 101 or may obtain the security level by calculation. The security level is an index indicating how secure the node, i.e., the computer, is.

Determiner 103 determines, from among the plurality of nodes 20, etc., a node (also referred to as a destination node) that is a destination for the transaction data to be transmitted. Here, determiner 103 preferentially determines a node having a higher security level as the destination node for the transaction data. When determiner 103 determines the destination node for the transaction data, determiner 103 can transmit the transaction data obtained by obtainer 102 to the destination node via communicator 101.

FIG. 3 is a flowchart illustrating processes performed by control device 10 according to the present exemplary embodiment. The processes performed by control device 10 can also be described as a control method for controlling system 1.

In Step S1, obtainer 102 obtains the transaction data to be stored into the distributed ledger.

In Step S2, obtainer 102 obtains the security level of each of the plurality of nodes 20, etc.

In Step S3, determiner 103 preferentially determines a node whose security level obtained in Step S2 is higher among the plurality of nodes 20, etc., as a destination node for the transaction data obtained in Step S1.

In Step S4, communicator 101 transmits the transaction data obtained in Step S1 to the destination node determined in Step S3.

In this manner, control device 10 minimizes the decrease in the reliability of transaction data that is stored into a distributed ledger.

### Embodiment 2

The present exemplary embodiment will more specifically describe a control method, etc., in which the decrease in the reliability of transaction data that is stored into a distributed ledger is minimized.

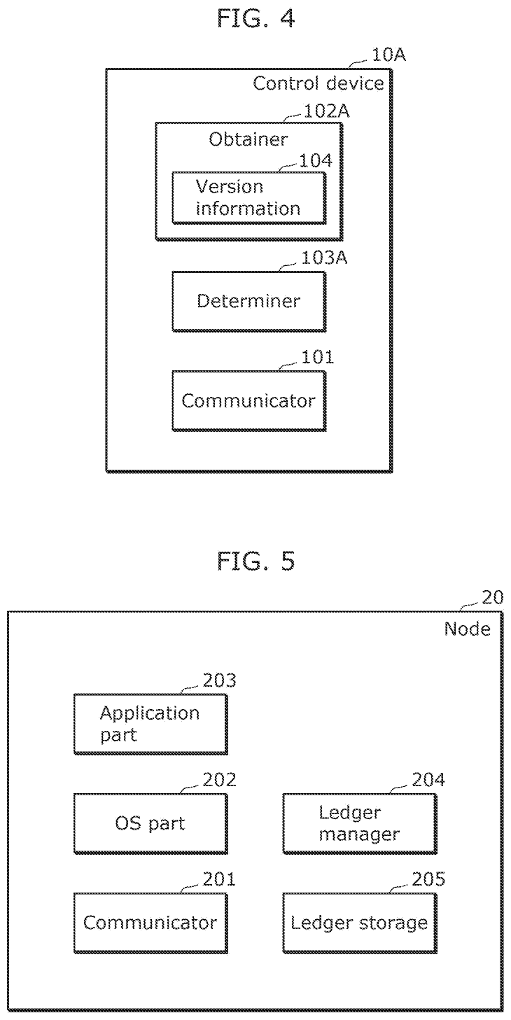

FIG. 4 is a block diagram schematically illustrating the functions of control device 10A according to the present exemplary embodiment. Control device 10A represents greater details of the functions of control device 10 according to Embodiment 1.

As illustrated in FIG. 4, control device 10A includes communicator 101, obtainer 102A, and determiner 103A as function parts. The functions parts included in control device 10A may each be provided by a processor (for example, a CPU (not illustrated in the Drawings)) executing a predetermined program using memory (not illustrated in the Drawings).

Communicator 101 is substantially the same as the communicator according to Embodiment 1.

Obtainer 102A represents greater details of obtainer 102 according to Embodiment 1. Obtainer 102A obtains the transaction data to be stored into the distributed ledger. Obtainer 102A obtains the transaction data via communicator 101. Furthermore, obtainer 102A obtains the security level of each of the plurality of nodes 20, etc., by calculation. The security level is an index indicating how secure the node, i.e., the computer, is; for example, the security level may be expressed in an integer value ranging from 0 to 100 or a numerical value ranging from 1 to 5 or may be expressed in two stages, “high” and “low”. Note that the expression of the security level is not limited to these.

Obtainer 102A further includes a function of managing the version of the plurality of nodes 20, etc. In order to obtain the security level, obtainer 102A obtains, from distribution server 30, etc., version information indicating the version of a software product included in each of the plurality of nodes 20, etc. Obtainer 102A holds the obtained version information as version information 104. When obtainer 102A obtains new version information, obtainer 102A updates version information 104 by holding the obtained new version information as version information 104. In this manner, obtainer 102A holds the current version of the software product included in each of the plurality of nodes 20, etc.

In the obtaining of the security level, obtainer 102A sets the security level of a node including a newer version of a software product to a higher security level on the basis of version information 104, and thus obtains the security level.

More specifically, in the obtaining of the security level, obtainer 102A may set the security level of a node among the plurality of nodes 20, etc., that has a smaller version difference indicating that the difference between the version of the software product included in said node and the newest version (also referred to as the latest version) available for said node is smaller to a higher security level on the basis of version information 104, and thus obtain the security level. The case where obtainer 102A obtains the security level as just described will be described herein as an example.

Determiner 103A represents greater details of determiner 103 according to Embodiment 1. Determiner 103A determines a destination node for the transaction data. Determiner 103A preferentially determines a node having a higher security level as the destination node for the transaction data. When the destination node for the transaction data is determined, determiner 103A can transmit the transaction data obtained by obtainer 102A to the destination node via communicator 101.

In the determining of the destination node, determiner 103A determines an authorized node from among the plurality of nodes 20, etc., and determines, as the destination node, the authorized node that has been determined. The authorized node is a node authorized to determine whether to store the transaction data into the distributed ledger.

Note that determiner 103A may determine a node having a security level greater than or equal to a threshold value among the plurality of nodes 20, etc., as the authorized node or the destination node.

Furthermore, determiner 103A may determine a predetermined number of nodes in descending order of the security level among the plurality of nodes 20, etc., as the authorized node or the destination node or may determine a predetermined percentage of nodes in descending order of the security level among the plurality of nodes 20, etc., as the authorized node or the destination node.

Furthermore, determiner 103A may determine a randomly selected node having a security level greater than or equal to a threshold value among the plurality of nodes 20, etc., as the authorized node or the destination node.

Note that an incentive may be provided to the node determined as the authorized node or the destination node in the above-described manner. The incentive may be, for example, value information. The incentive may be exchanged by storing, into the distributed ledger held by node 20, etc., transaction data in which the exchange of the incentive has been recorded. This makes it possible to motivate the manager of a node to maintain a high security level of the node and as a result, contribute to maintaining the high security level of the node.

Note that obtainer 102A can more easily obtain the security level using performance of the processor (for example, the CPU) included in each of the plurality of nodes 20, etc. In this case, obtainer 102A may obtain the security level by setting the security level of a node including a higher-performance processor to a higher security level.

Note that obtainer 102A can also more easily obtain the security level using the credibility of a user, a manager, or a manufacturer of each of the plurality of nodes 20, etc. In this case, obtainer 102A may obtain the security level by setting the security level of a node related to a user, a manager, or a manufacturer with higher credibility to a higher security level.

Note that obtainer 102A can also more easily obtain the security level using the credibility of an application software product included in each of the plurality of nodes 20, etc. In this case, obtainer 102A may obtain the security level by setting the security level of a node including an application software product with higher credibility to a higher security level.

Note that obtainer 102A can also more easily obtain the security level using the number of application software products included in each of the plurality of nodes 20, etc. In this case, obtainer 102A may obtain the security level by setting the security level of a node including a greater number of application software products to a higher security level.

Note that obtainer 102A can also more easily obtain the security level using the credibility of a past communication counterpart of each of the plurality of nodes 20, etc. In this case, obtainer 102A may obtain the security level by setting the security level of a node that has communicated in the past with a counterpart with higher credibility to a higher security level.

Note that obtainer 102A may further obtain an evaluation value of each of the plurality of nodes 20 that is to be used by determiner 103A to determine the authorized node. In this case, in the determining of the authorized node from among the plurality of nodes 20, etc., determiner 103A may determine the authorized node on the basis of the security level in principle, but determine the authorized node using the evaluation value as an exception for nodes having the same security level. At this time, determiner 103A preferentially determines a node having a higher evaluation value as the authorized node.

Obtainer 102A can obtain the evaluation value corresponding to the update time of the software product included in each of the plurality of nodes 20, etc. In this case, obtainer 102A may obtain the evaluation value by setting the evaluation value of a node in which the update time of the software product is earlier to a higher evaluation value. This makes it possible to contribute to maintaining the high security level of the node.

Obtainer 102A can obtain the evaluation value according to a security level transition of each of the plurality of nodes 20, etc. In this case, obtainer 102A may obtain the evaluation value by setting the evaluation value of a node continuously having a higher security level to a higher evaluation value. Furthermore, obtainer 102A may obtain the evaluation value by setting, to a higher evaluation value, the evaluation value of a node having a security level that when the security level decreases in the security level transition, increases faster after the decrease. This makes it possible to contribute to maintaining the high security level of the node.

FIG. 5 is a block diagram schematically illustrating the functions of node 20 according to the present exemplary embodiment. Note that nodes 21, 22 are substantially the same as node 20 and therefore, detailed description thereof will be omitted.

As illustrated in FIG. 5, node 20 includes communicator 201, OS part 202, application part 203, ledger manager 204, and ledger storage 205 as function parts. The functions parts included in node may each be provided by a processor (for example, a CPU (not illustrated in the Drawings)) executing a predetermined program using memory (not illustrated in the Drawings).

Communicator 201 is a communication interface that can be connected to network N. Communicator 201 is substantially the same as communicator 101 of control device 10 according to Embodiment 1. Communicator 201 receives a software product from distribution server 30, etc., and receives transaction data from terminal 40, etc.

OS part 202, which is a function part that is provided by the operating system of node 20, manages a file, memory, or a process in node 20, for example. OS part 202 is realized by executing the OS, which is a software product.

Application part 203, which is a function part that is provided by an application software product included in node 20, creates text and the like, calculates or organizes numerical data, or performs sound or image processing, for example. Application part 203 is realized by executing the application software product, which is a software product. Note that an “application” stands for an application software product.

Ledger manager 204 performs processes related to the transaction data to be stored into the distributed ledger stored in ledger storage 205. The processes performed by ledger manager 204 differ depending on whether node 20 including this ledger manager 204 is the authorized node.

In the case where node 20 including ledger manager 204 is the authorized node, when communicator 201 receives the transaction data and verification of the validity of the received transaction data is successful, ledger manager 204 performs a block generation process. Examples of the verification of the validity include verifying whether an electronic signature included in the transaction data is authentic. When the verification of the validity is not successful, the received transaction data is discarded. In this manner, the block generation process is performed only on a transaction, the validity of which has been successfully verified; therefore, unnecessary processor usage can be reduced. In the block generation process, ledger manager 204 determines whether to store the received transaction data into the distributed ledger. Subsequently, when ledger manager 204 determines that the received transaction data is to be stored into the distributed ledger, ledger manager 204 performs the process of storing said transaction data into the distributed ledger. In storing the transaction data into the distributed ledger, ledger manager 204 stores the transaction data into the distributed ledger using a method suitable for the type of the distributed ledger. Furthermore, ledger manager 204 transmits and receives communication data via communicator 201 to and from ledger manager 204 included in another node among nodes 20, etc., and causes the distributed ledger included in the other node to store said transaction data. Note that ledger manager 204 does not need to transmit the transaction data to a node other than the destination node among nodes 20, etc. This allows a reduction in the amount of processing to be performed by the processor of node 20.

When node 20 including ledger manager 204 is not the authorized node, ledger manager 204 does not perform the block generation process, in other words, the execution of the block generation process is hindered, even when communicator 201 receives the transaction data. Note that even in this case, ledger manager 204 can perform the process of storing, into the distributed ledger, the transaction data received from other nodes 20, etc.

The distributed ledger is, for example, a blockchain; this case will be described as an example. When the distributed ledger is a blockchain, the authority to determine whether to store the transaction data into the distributed ledger corresponds to the authority to determine whether to generate a block including the transaction data. When node 20 is the authorized node and communicator 201 receives the transaction data, ledger manager 204 performs processing related to the generation of a block including the received transaction data (also referred to as the block generation process). In the block generation process, ledger manager 204 determines whether to generate a block including the received transaction data. Subsequently, when ledger manager 204 determines that a block including the received transaction data is to be generated, ledger manager 204 generates a block including the received transaction data and provides the generated block to other nodes so that the generated block is connected to the blockchain at each node. At this time, an agreement on the generated block may be made with the other nodes according to a predetermined consensus algorithm. When an agreement is successfully made according to a predetermined consensus algorithm, the generated block is connected to the blockchain stored in ledger storage 205. In this manner, only a block on which an agreement has been successfully made according to the predetermined consensus algorithm is connected to the blockchain, and a block on which an agreement has not been successfully made is not connected to the blockchain; therefore, unnecessary memory usage can be reduced. Note that in the block generation process, when ledger manager 204 determines that a block including the received transaction data is not to be generated, ledger manager 204 does not generate the block. This allows a reduction in the amount of processing to be performed by the processor.

Ledger storage 205 is storage (in other words, a storage device) in which the distributed ledger is stored. The distributed ledger stored in ledger storage 205 is a distributed ledger into which the transaction data generated by terminal 40 is stored. The distributed ledger stored in ledger storage 205 can store one or more items of transaction data, and the transaction data stored therein is managed in a tamper-proof manner using the features of a hash function and the like (which will be described later). Ledger storage 205 stores, into the distributed ledger, the transaction data provided from ledger manager 204. The past to current transaction data is stored in the distributed ledger. The transaction data is managed so as not to be tampered with on the basis of characteristics in which information recorded in the distributed ledger is difficult to tamper with.

Note that IOTA, hashgraph, or the like can be used as the distributed ledger. Examples of the consensus algorithm include practical Byzantine fault tolerance (PBFT), proof of work (PoW), and proof of stake (PoS).

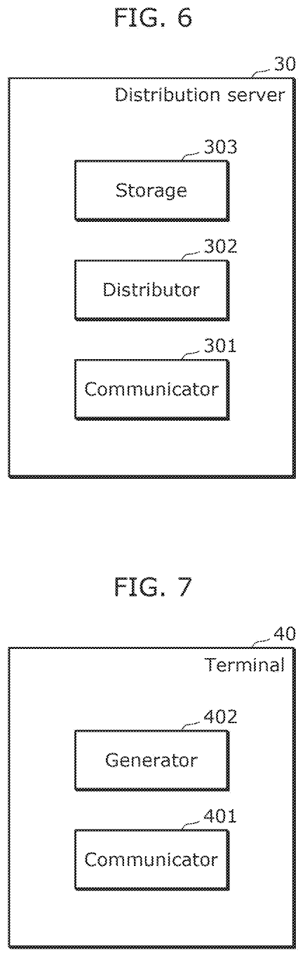

FIG. 6 is a block diagram schematically illustrating the functions of distribution server 30 according to the present exemplary embodiment.

As illustrated in FIG. 6, distribution server 30 includes communicator 301, distributor 302, and storage 303 as function parts. The functions parts included in distribution server 30 may each be provided by a processor (for example, a CPU (not illustrated in the Drawings)) executing a predetermined program using memory (not illustrated in the Drawings).

Communicator 301 is a communication interface that can be connected to network N. Communicator 301 is substantially the same as communicator 101 of control device 10 according to Embodiment 1. Communicator 301 transmits the software product to be distributed to node 20, etc., and provides the version information to control device 10A.

Distributor 302 distributes a software product to node 20, etc. The software product that is distributed by distributor 302 is a software product to be used by node 20, etc., and may include an operating system (OS), an application software product, or a device software product.

Distributor 302 transmits, to control device 10A, latest version information indicating the latest version of the software product to be used by node 20, etc. Furthermore, when distributor 302 distributes the software product to node 20, etc., distributor 302 transmits, to control device 10A, current version information indicating the version of the distributed software product, together with information indicating a counterpart, i.e., a node, to which the software product has been distributed.

Storage 303 is storage in which the software product to be distributed to node 20, etc., is stored. The software product that is stored in storage 303 is stored by the manager of the software product and is read and distributed to node 20 by distributor 302, for example. Furthermore, when the software product is updated, the updated software is stored into storage 303, and thereafter the updated software is read and distributed by distributor 302.

FIG. 7 is a block diagram schematically illustrating the functions of terminal 40 according to the present exemplary embodiment.

As illustrated in FIG. 7, terminal 40 includes communicator 401 and generator 402 as function parts. The functions parts included in terminal 40 may each be provided by a processor (for example, a CPU (not illustrated in the Drawings)) executing a predetermined program using memory (not illustrated in the Drawings).

Communicator 401 is a communication interface that can be connected to network N. Communicator 401 is substantially the same as communicator 101 of control device 10 according to Embodiment 1.

Generator 402 generates the transaction data to be stored into the distributed ledger. Generator 402 transmits the generated transaction data to control device 10A via communicator 401.

Next, the version information that is used by control device 10A will be described. The version information includes: latest version information indicating the latest version of the software product included in node 20, etc.; and current version information indicating the current version of the software product included in node 20, etc. These will be described in sequence.

### (1) Latest Version Information

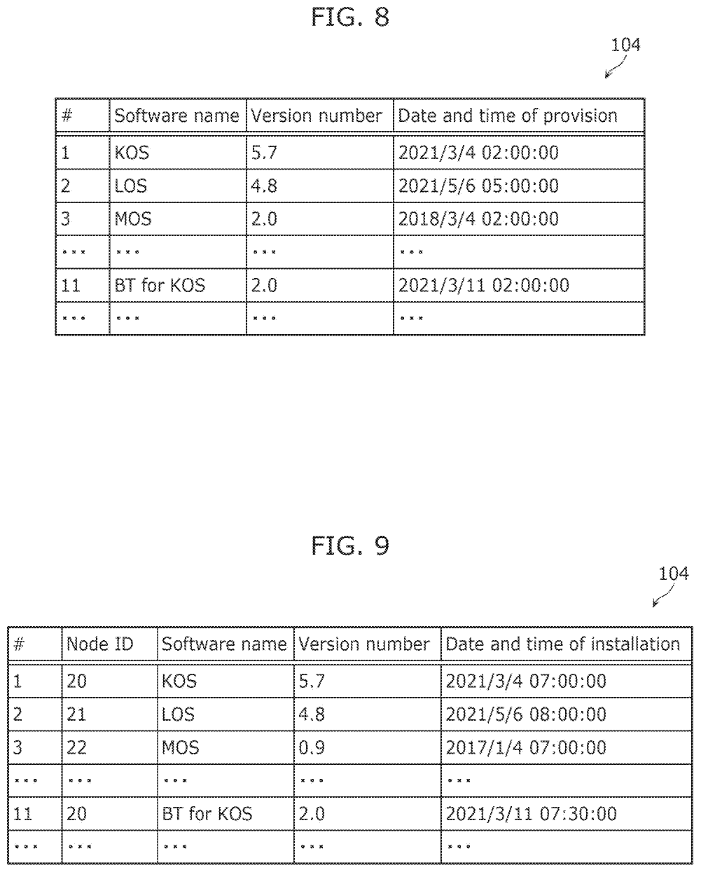

FIG. 8 is an explanatory diagram illustrating the latest version information that is the first example of the version information according to the present exemplary embodiment.

As illustrated in FIG. 8, the latest version information includes a software name, a version number, and a date and time of provision of the software product included in node 20, etc., in association with each other.

The software name indicates the name of said software product. The version number is a number indicating the latest version of said software product. Note that the version number may be more generally an identifier that can uniquely identify a version.

The date and time of provision indicates a date and time on which the latest version of said software product was provided (or released).

For example, entry #1 indicated in FIG. 8 shows that the latest version of the software product with the name “KOS” is 5.7 and that said software product was provided at 2:00:00 on Mar. 4, 2021. Note that the term “KOS” may refer to an OS manufactured by company K.

Furthermore, entry #11 indicated in FIG. 8 shows that the latest version of the software product with the name “BT for KOS” is 2.0 and that said software product was provided at 2:00:00 on Mar. 11, 2021. Note that “BT for KOS” may refer to a driver software product that operates on the OS manufactured by company K and controls Bluetooth (registered trademark).

### (2) Current Version Information

FIG. 9 is an explanatory diagram illustrating the current version information that is the second example of the version information according to the present exemplary embodiment.

As illustrated in FIG. 9, the current version information includes a node ID, a software name, a version number, and a date and time of installation of the software product included in node 20, etc., in association with each other.

The node ID indicates the identifier of the node including said software product.

The software name indicates the name of said software product.

The version number is a number indicating the current version of said software product included in the node including said software product. It is sufficient that the version number be more generally an identifier that can uniquely identify a version.

The date and time of installation indicates a date and time on which said software product was included in said node.

For example, entry #1 indicated in FIG. 9 shows that the current version of the software product with the name “KOS” included in node 20 is 5.7 and that said software product was installed at 7:00:00 on Mar. 4, 2021.

Furthermore, entry #11 indicated in FIG. 9 shows that the current version of the software product with the name “BT for KOS” included in node 20 is 2.0 and that said software product was installed at 7:30:00 on Mar. 11, 2021.

With reference to the latest version information illustrated in FIG. 8 and the current version information illustrated in FIG. 9, obtainer 102A can set and thus obtain the security level as follows, for example.

Specifically, obtainer 102A sets the security level of node 20 to a relatively high security level on the basis of the fact that the latest version of the KOS, that is, 5.7, and the current version of the KOS included in node 20, that is, 5.7, are determined to match each other.

Furthermore, obtainer 102A sets the security level of node 21 to a relatively high security level on the basis of the fact that the latest version of the LOS, that is, 4.8, and the current version of the LOS included in node 21, that is, 4.8, are determined to match each other. The set security level may be a security level comparable to the security level of node 20.

Furthermore, obtainer 102A sets the security level of node 22 to a security level lower than the security level of node 20 or 21 on the basis of the fact that the latest version of the MOS, that is, 2.0, and the current version of the MOS included in node 22, that is, 0.9, are determined to differ by 1.1.

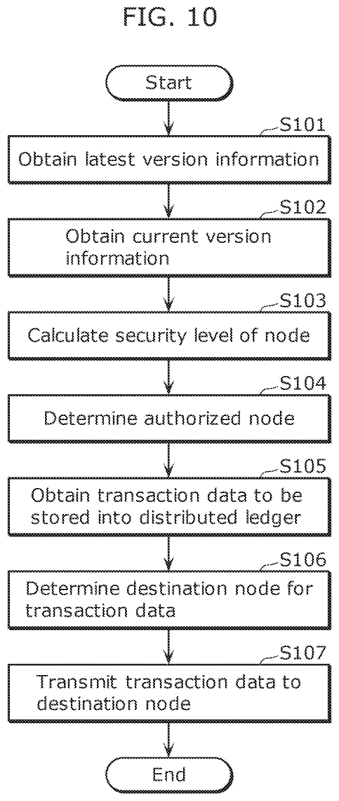

FIG. 10 is a flowchart illustrating processes and an algorithm performed by control device 10A according to the present exemplary embodiment.

In Step S101, obtainer 102A obtains, from distribution server 30, etc., the latest version information indicating the latest version of the software product included in each of the plurality of nodes 20, etc. Obtainer 102A holds the obtained latest version information by including the obtained latest version information in version information 104.

In Step S102, obtainer 102A obtains, from distribution server 30, etc., current version information indicating the current version of the software product included in each of the plurality of nodes 20, etc. Obtainer 102A holds the obtained current version information by including the obtained current version information in version information 104.

In Step S103, obtainer 102A calculates the security level of each of the plurality of nodes 20, etc. In the calculation of the security level, the latest version information and the current version information held by obtainer 102A may be used.

In Step S104, determiner 103A determines an authorized node using the security level calculated in Step S103.

In Step S105, obtainer 102A obtains the transaction data to be stored into the distributed ledger. Obtainer 102A obtains, as the transaction data, the transaction data generated and transmitted by terminal 40.

In Step S106, determiner 103A determines a destination node for the transaction data. Determiner 103A determines, as a destination node for the transaction data, the authorized node that has been determined in Step S104.

In Step S107, communicator 101 transmits the transaction data obtained in Step S105 to the destination node determined in Step S106.

Note that in the series of processes illustrated in FIG. 10, Steps S103, S104 may be performed after Step S105.

Next, processes performed by system 1 will be described.

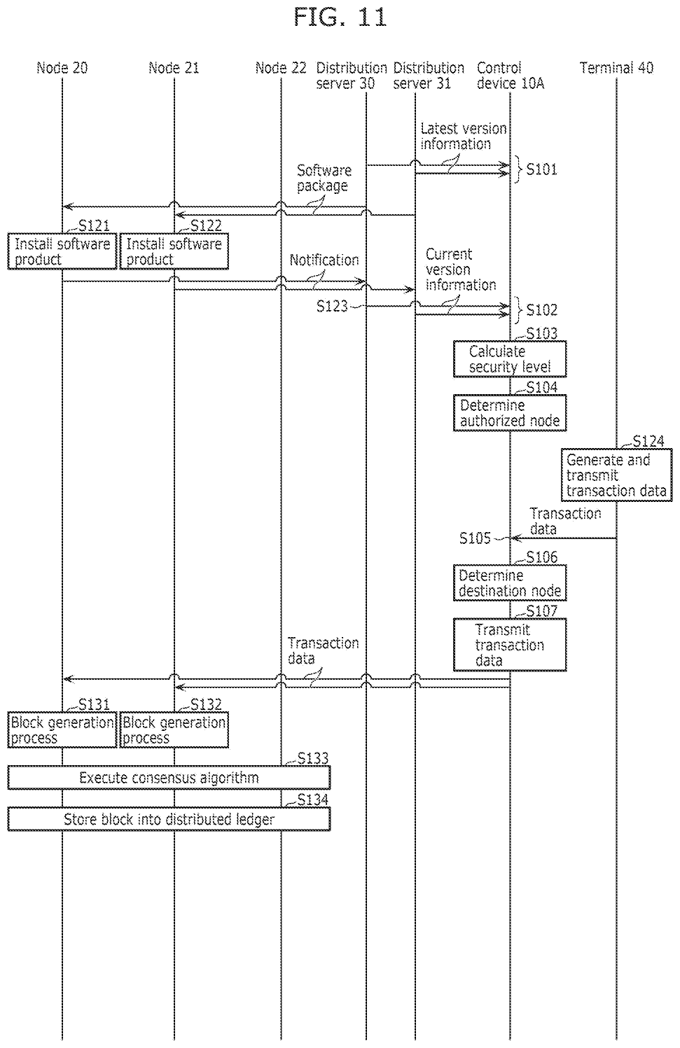

FIG. 11 is the first sequence chart illustrating the processes and an algorithm performed by system 1 according to Embodiment 2. Note that in FIG. 11, processes that are the same as the processes illustrated in FIG. 10 are assigned the same reference signs, and detailed description of the processes may be omitted.

In Step S101, control device 10A obtains the latest version information from distribution server 30, etc.

In Step S121, a software product is installed on node 20. The software product may be installed using an automatic installation function operating on node 20 or may be installed manually by a manager who manages node 20. For installation of the software product, node 20 obtains a package including a software program (also referred to as a software package) from distribution server 30 via communication. Furthermore, when the installation of the software product is completed, node 20 transmits a notification indicating the completion of the installation of the software product to distribution server 30.

In Step S122, a software product is installed on node 21. The software product is installed on node 21 by a process that is substantially the same as the process on node 20 using the software package obtained from distribution server 31.

In Step S102, control device 10A obtains the current version information transmitted (Step S123) by distribution server 30, etc. The current version information is version information indicating the version of the software product installed on nodes 20, 21 in Steps S121, S122.

In Steps S103 to S104, control device 10A calculates the security level of each of the plurality of nodes 20, etc., and determines an authorized node. The following will describe, as an example, the case where control device 10A has determined nodes 20, 21 as authorized nodes.

In Step S124, terminal 40 generates transaction data and transmits the transaction data to control device 10A.

In Steps S105 to S107, control device 10A receives the transaction data transmitted by terminal 40, determines a destination node, and transmits the transaction data to the destination node. Since nodes 20, 21 have been determined as the authorized nodes (Step S104), control device 10A determines nodes 20, 21 as destination nodes and transmits the transaction data to nodes 20, 21. Nodes 20, 21 receive the transaction data transmitted thereto. Therefore, since the transaction data is only transmitted to nodes 20, 21, it is possible to reduce network congestion and the amount of processing and power consumed in a computer or a processor, thereby providing improvements in computer-functionality.

In Step S131, node 20 performs the block generation process related to the generation of a block including the transaction data received in Step S107.

In Step S132, node 21 performs the block generation process related to the generation of a block including the transaction data received in Step S107 as in Step S131.

In Step S133, the plurality of nodes 20 execute the consensus algorithm. In the execution of the consensus algorithm, the plurality of nodes 20 make an agreement by transmitting and receiving the block generated in Step S131 or S132 to and from each other. At this time, when there are a plurality of blocks generated such as when blocks are generated in both Steps S131, S132, the block to be stored into the distributed ledger may be determined from among the plurality of blocks.

In Step S134, each of the plurality of nodes 20 stores, into the distributed ledger, the block on which the agreement has been made in Step S133. When the block to be stored into the distributed ledger is determined from among the plurality of blocks in Step S133, the determined block is stored into the distributed ledger.

Through the series of processes illustrated in FIG. 11, nodes 20, 21 each having a relatively high security level determines whether to store the block into the distributed ledger, in other words, node 22 having a relatively low security level is restricted from determining whether to store the block into the distributed ledger. In this manner, control device 10A minimizes the decrease in the reliability of the transaction data to be stored into the distributed ledger.

Note that the processing in which control device 10A transmits the transaction data to each destination node determined (that is, unicast) has thus far been described with reference to FIG. 11, but control device 10A may instead broadcast the transaction data and node 20, etc., that has received the transaction data may determine whether to perform the block generation process. Two examples of such processing will be described. Here, information indicating the authorized node will be referred to as authorization information.

### (1) Example in which Authorization Information is Transmitted Separately from Transaction Data

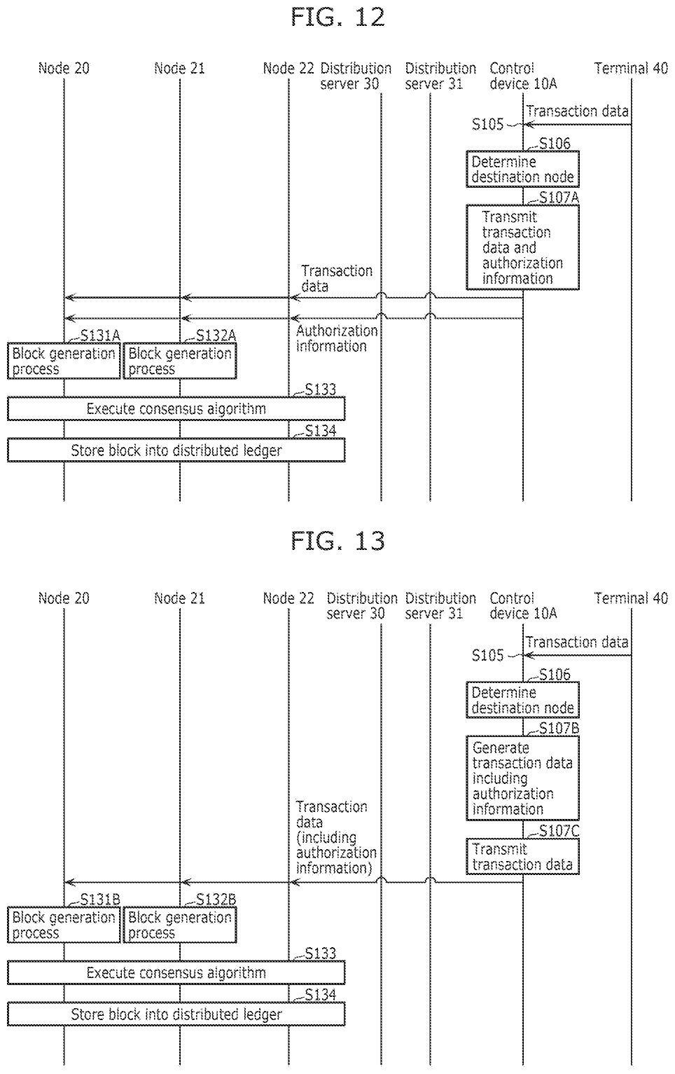

For example, control device 10A may broadcast the transaction data and further broadcast the authorization information separately from the transaction data. Processes performed by system 1 in this case will be described with reference to FIG. 12.

FIG. 12 is the second sequence chart illustrating the processes and an algorithm performed by system 1 according to the present exemplary embodiment. The sequence chart illustrated in FIG. 12 corresponds to a variation of the processes from Step S105 onward in FIG. 11. Note that in FIG. 12, processes that are the same as the processes illustrated in FIG. 11 are assigned the same reference signs, and detailed description of the processes may be omitted.

As illustrated in FIG. 12, after determining a destination node (Step S106), control device 10A broadcasts the transaction data and further broadcasts the authorization information separately from the transaction data (Step S107A). Nodes 20, etc., receive the transaction data and the authorization information transmitted thereto. Here, assume that the authorization information indicates that nodes 20, 21 are authorized nodes.

Nodes 20, 21 perform the block generation process (Step S131A and Step S132A) on the basis of the fact that the authorization information received in Step S107A indicates that the nodes themselves are authorized nodes. Details of the block generation process are substantially the same as those in Step S131 and Step S132 indicated in FIG. 11.

On the other hand, node 22 does not perform the block generation process (in other words, the block generation process is restricted from being performed) because the authorization information received in Step S107A does not indicate that the node itself is an authorized node.

Subsequently, each of the plurality of nodes 20, etc., stores the block into the distributed ledger (Step S134) after executing the consensus algorithm (Step S133).

### (2) Example in which Transaction Data Including Authorization Information is Transmitted

For example, control device 10A may broadcast the transaction data including the authorization information. Processes performed by system 1 in this case will be described with reference to FIG. 13.

FIG. 13 is the third sequence chart illustrating the processes performed by system 1 according to the present exemplary embodiment. The sequence chart illustrated in FIG. 13 corresponds to a variation of the processes from Step S105 onward in FIG. 11. Note that in FIG. 13, processes that are the same as the processes illustrated in FIG. 11 are assigned the same reference signs, and detailed description of the processes may be omitted.

As illustrated in FIG. 13, after determining a destination node (Step S106), control device 10A generates transaction data that includes content that is the same as the content of the transaction data received from terminal 40 in Step S105 and further includes the authorization information (Step S107B). Here, assume that the authorization information indicates that nodes 20, 21 are authorized nodes.

Subsequently, control device 10A broadcasts the transaction data generated in Step S107B (Step S107C). Each of the plurality of nodes 20, etc., receives the transaction data transmitted thereto.

Nodes 20, 21 perform the block generation process on the basis of the fact that the authorization information included in the transaction data received in Step S107C indicates that the nodes themselves are authorized nodes (Step S131B and Step S132B). Details of the block generation process are substantially the same as those in Step S131 and Step S132 indicated in FIG. 11.

On the other hand, node 22 does not perform the block generation process (in other words, the block generation process is restricted from being performed) because the authorization information included in the transaction data received in Step S107C does not indicate that the node itself is an authorized node.

Subsequently, each of the plurality of nodes 20, etc., stores the block into the distributed ledger (Step S134) after executing the consensus algorithm (Step S133).

In this manner, as in the case of FIG. 10, control device 10A can minimize the decrease in the reliability of transaction data that is stored into a distributed ledger.

### Embodiment 3

The present exemplary embodiment will more specifically describe a control method, etc., in which the decrease in the reliability of transaction data that is stored into a distributed ledger is minimized. In the control method according to the present exemplary embodiment, the decrease in the reliability of transaction data that is stored into a distributed ledger can be minimized while the security level of a specific version of a software product is set low.

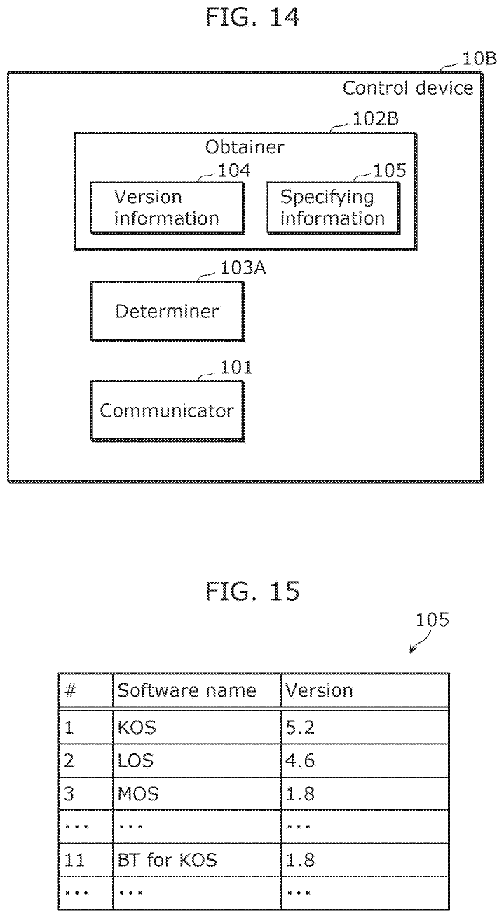

FIG. 14 is a block diagram schematically illustrating the functions of control device 10B according to the present exemplary embodiment.

As illustrated in FIG. 14, control device 10B includes communicator 101, obtainer 102B, and determiner 103A as function parts. The functions parts included in control device 10B may each be provided by a processor (for example, a CPU (not illustrated in the Drawings)) executing a predetermined program using memory (not illustrated in the Drawings).

Communicator 101 is substantially the same as communicator 101 according to Embodiment 1.

Obtainer 102B represents greater details of obtainer 102 according to Embodiment 1. Obtainer 102B obtains the transaction data to be stored into the distributed ledger. Furthermore, obtainer 102B obtains the security level of each of the plurality of nodes 20, etc. Moreover, obtainer 102B obtains the transaction data via communicator 101.

In the obtaining of the security level, obtainer 102B obtains: version information indicating the version of a software product included in each of the plurality of nodes 20, etc.; and specifying information indicating a specific version of the software product.

Similar to obtainer 102A according to Embodiment 2, obtainer 102B holds, as version information 104, the current version of the software product included in each of the plurality of nodes 20, etc.

Furthermore, obtainer 102B obtains specifying information indicating a specific version of the software product and holds the specifying information as specifying information 105. The specific version of the software product is a version of the software product presumed to be inappropriate for a node including said version to perform the block generation process; specifically, the specific version includes a version of the software product known to lead to operational malfunctions or vulnerabilities. The specific version of the software product may be predetermined, for example, by a manager who manages the software product. Note that the specifying information may be a specific version set of a plurality of software products.

Subsequently, in the obtaining of the security level, obtainer 102B sets the security level of a node including a predetermined specific version of the software product to a lower security level on the basis of specifying information 105, and thus obtains the security level.

Note that when the specifying information is the specific version set of the plurality of software products, for example, in the obtaining of the security level, obtainer 102B can set the security level of a node including a specific set of the version of the operating system and the version of the driver software to a lower security level on the basis of version information indicating the version of the operation system (that corresponds to the first version information) and version information indicating the version of the driver software (that corresponds to the second version information), and thus obtain the security level. The first version information and the second version information are those obtained by obtainer 102B.

Determiner 103A represents greater details of determiner 103 according to Embodiment 1 and is substantially the same as determiner 103A according to Embodiment 2.

FIG. 15 is an explanatory diagram illustrating the first example of specifying information 105 according to the present exemplary embodiment.

Specifying information 105 illustrated in FIG. 15 is information for specifying a vulnerable software version.

For example, entry #1 indicates that version 5.2 of KOS, which is a software product, is vulnerable.

Furthermore, entry #11 indicates that version 1.8 of “BT for KOS”, which is a software product, is vulnerable.

With reference to version information 104, obtainer 102B determines whether any of the versions of the software products included in node 20, etc., is included in specifying information 105.

Subsequently, obtainer 102B sets the security level of a node including a software product whose version is included in specifying information 105, among nodes 20, etc., to a lower security level.

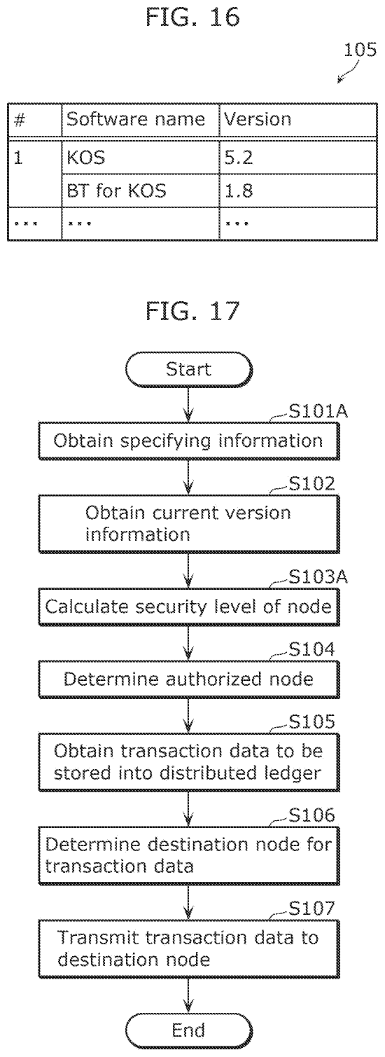

FIG. 16 is an explanatory diagram illustrating the second example of the specifying information according to the present exemplary embodiment.

Specifying information 105 illustrated in FIG. 16 is information for specifying a specific version set of a plurality of software products, and more specifically is information for specifying a vulnerable version set of software products.

For example, entry #1 indicates that the combination of version 5.2 of KOS, which is a software product, and version 1.8 of “BT for KOS”, which is a software product, is vulnerable.

With reference to version information 104, obtainer 102B determines whether any of the version combinations of the software products included in node 20, etc., is included in specifying information 105. Subsequently, obtainer 102B sets the security level of a node including a combination of software products whose versions are included in specifying information 105, among nodes 20, etc., to a lower security level.

FIG. 17 is a flowchart illustrating processes performed by control device 10B according to the present exemplary embodiment.

In Step S101A, obtainer 102B obtains, from distribution server 30, etc., specifying information regarding a software product included in each of the plurality of nodes 20, etc. Obtainer 102B holds the obtained specifying information as specifying information 105.

In Step S102, obtainer 102B obtains, from distribution server 30, etc., current version information indicating the current version of the software product included in each of the plurality of nodes 20, etc. Obtainer 102B holds the obtained current version information as version information 104.

In Step S103A, obtainer 102B calculates the security level of each of the plurality of nodes 20, etc. In the calculation of the security level, the current version information and the specifying information held by obtainer 102B may be used. At this time, obtainer 102B sets the security level of a node including a version of a software product that is specified in the specifying information to a low security level.

In Steps S104 to S107, similar to control device 10A according to Embodiment 2, control device 10B determines an authorized node and a destination node and transmits the transaction data to the destination node.

In this manner, control device 10B can minimize the decrease in the reliability of transaction data that is stored into a distributed ledger while setting the security level of a specific version of a software product (or a specific version set of software products) to a low security level.

### Embodiment 4

The present exemplary embodiment will more specifically describe a control method, etc., in which the decrease in the reliability of transaction data that is stored into a distributed ledger is minimized. In the control method according to the present exemplary embodiment, the functions of control device 10 according to Embodiment 1 are provided as functions of distribution server 30A, etc., and terminal 40A.

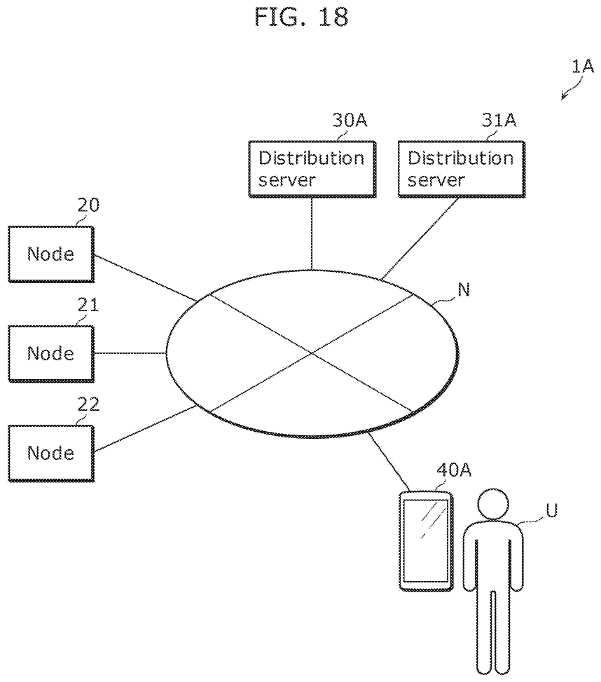

FIG. 18 is a block diagram schematically illustrating system 1A according to the present exemplary embodiment.

As illustrated in FIG. 18, system 1A includes at least a plurality of nodes 20, etc. Furthermore, system 1A may include one or more devices that are distribution servers 30A, 31A (also referred to as distribution server 30A, etc.) and terminal 40A. The plurality of nodes 20, etc., and the one or more devices included in system 1A are connected to network N and can communicate with each other via network N.

The plurality of nodes 20, etc., are the same as the plurality of nodes 20, etc., according to Embodiment 1. A distributed ledger held by each of the plurality of nodes 20, etc., corresponds to the first distributed ledger.

Similar to distribution server 30, etc., according to Embodiment 1, distribution server 30A is a server that distributes a software product to be used in node 20 and is provided as a computer. Distribution server 30A is one of distribution servers 30A, etc., each of which holds a distributed ledger (corresponding to the second distributed ledger) in which the version of the software product distributed to the node is managed.

Similar to distribution server 31, etc., according to Embodiment 1, distribution server 31A is a server that distributes a software product to be used in node 21 and is provided as a computer. Distribution server 31A is one of distribution servers 30A, etc., each of which holds a distributed ledger (corresponding to the second distributed ledger) in which the version of the software product distributed to the node is managed.

Note that two distribution servers are illustrated as an example of distribution server 30A, etc., but there may be more distribution servers.

Similar to terminal 40 according to Embodiment 1, terminal 40A is a device that generates transaction data to be stored into the distributed ledger held by system 1A. Furthermore, terminal 40A obtains version information by referring to the distributed ledger managed by the plurality of distribution servers 30A, etc., and determines an authorized node and a destination node from among the plurality of nodes 20, etc., using the version information obtained. Terminal 40A transmits the generated transaction data to the destination node determined.

Note that system 1A does not include control device 10 according to Embodiment 1, etc., as a standalone device. In system 1A, terminal 40A includes the functions of control device 10 according to Embodiment 1, etc.; in other words, it can be said that terminal 40A corresponds to control device 10.

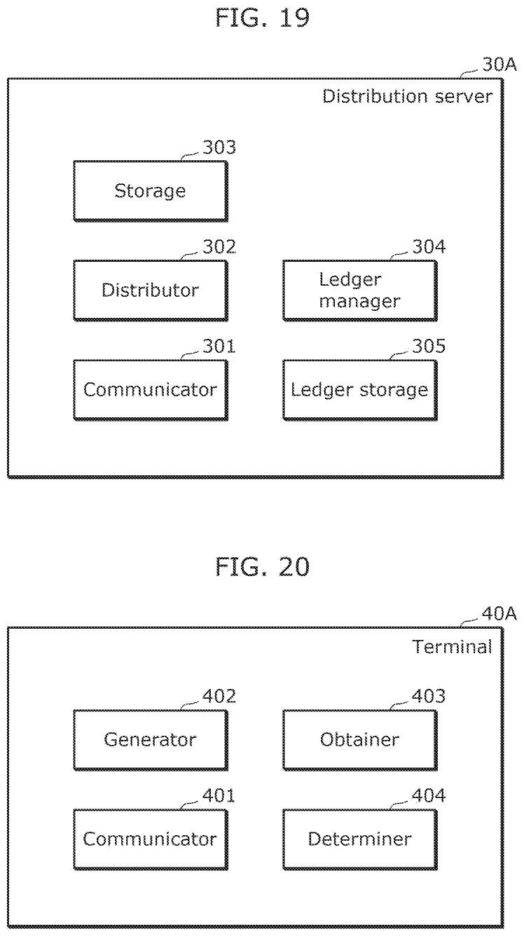

FIG. 19 is a block diagram schematically illustrating the functions of distribution server 30A according to the present exemplary embodiment.

As illustrated in FIG. 19, distribution server 30A includes communicator 301, distributor 302, storage 303, ledger manager 304, and ledger storage 305 as function parts. Communicator 301, distributor 302, and storage 303 are the same as structural elements having the same names according to Embodiment 2 and therefore, detailed description thereof will be omitted. The functions parts included in distribution server 30A may each be provided by a processor (for example, a CPU (not illustrated in the Drawings)) executing a predetermined program using memory (not illustrated in the Drawings).

Ledger manager 304 performs processes related to the transaction data to be stored into the distributed ledger stored in ledger storage 305. When communicator 301 receives the transaction data, ledger manager 304 performs the process of storing the received transaction data into the distributed ledger. In storing the transaction data into the distributed ledger, ledger manager 304 stores the transaction data into the distributed ledger using a method suitable for the type of the distributed ledger. Furthermore, ledger manager 304 transmits and receives communication data via communicator 301 to and from ledger manager 304 included in another distribution server among distribution server 30A, etc., and causes the distributed ledger included in the other distribution server to store said transaction data.

Ledger manager 304 stores the transaction data including the version information into the distributed ledger. The version information includes: latest version information indicating the latest version of the software product included in node 20, etc.; and current version information indicating the current version of the software product included in node 20, etc. (refer to FIG. 8 and FIG. 9)

Note that the distributed ledger is, for example, a blockchain; this case will be described as an example, but it is also possible to use a distributed ledger in another form as with ledger storage 205.

Ledger storage 305 is storage (in other words, a storage device) in which the distributed ledger is stored. The distributed ledger stored in ledger storage 305 is a distributed ledger in which the version information for each of the plurality of nodes 20, etc., is stored. The distributed ledger stored in ledger storage 305 can store one or more items of transaction data, and the transaction data stored therein is managed in a tamper-proof manner using the features of a hash function and the like (which will be described later). Ledger storage 305 stores, into the distributed ledger, the transaction data provided from ledger manager 304. The past to current transaction data is stored in the distributed ledger. The transaction data is managed so as not to be tampered with on the basis of characteristics in which information recorded in the distributed ledger is difficult to tamper with.

FIG. 20 is a block diagram schematically illustrating the functions of terminal 40A according to the present exemplary embodiment.

As illustrated in FIG. 20, terminal 40A includes communicator 401, generator 402, obtainer 403, and determiner 404 as function parts. Communicator 401 and generator 402 are the same as structural elements having the same names according to Embodiment 2 and therefore, detailed description thereof will be omitted. The functions parts included in terminal 40A may each be provided by a processor (for example, a CPU (not illustrated in the Drawings)) executing a predetermined program using memory (not illustrated in the Drawings).

Obtainer 403 represents greater details of obtainer 102 according to Embodiment 1. Obtainer 403 obtains the security level of each of the plurality of nodes 20, etc. In the obtaining of the security level, obtainer 403 refers to the distributed ledger managed by distribution server 30A, etc., and thus obtains version information indicating the version of a software product included in each of the plurality of nodes 20, etc. The process of obtaining the security level by obtainer 403 is substantially the same as the process performed by obtainer 102A according to Embodiment 2 or obtainer 1028 according to Embodiment 3.

Determiner 404 represents greater details of determiner 103 according to Embodiment 1. Determiner 404 determines a destination node for the transaction data. The process of determining a destination node for the transaction data by determiner 404 is the same as the process of determining a destination for the transaction data by determiner 103A according to Embodiment 2.

The processes performed by terminal 40A are substantially the same as the processes performed by control device 10A according to Embodiment 2 (refer to FIG. 10) except the following points.

Specifically, in the obtaining of the latest version information in Step S101, terminal 40A refers to the distributed ledger stored in distribution server 30A and thus obtains the latest version information.

Furthermore, in the obtaining of the current version information in Step S102, terminal 40A refers to the distributed ledger stored in distribution server 30A and thus obtains the current version information.

Furthermore, in the obtaining of the transaction data in Step S105, terminal 40A uses generator 402 to generate the transaction data and thus obtains the transaction data.

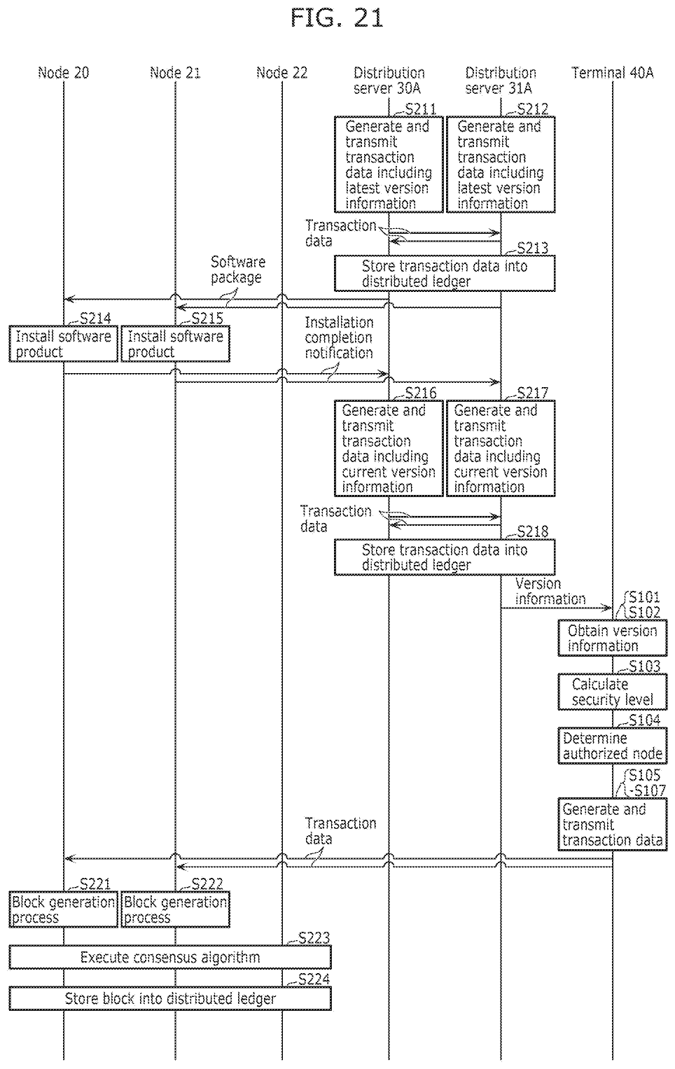

FIG. 21 is a sequence chart illustrating the processes performed by system 1A according to the present exemplary embodiment. Note that in FIG. 21, processes that are the same as the processes illustrated in FIG. 10 or FIG. 11 are assigned the same reference signs, and detailed description of the processes may be omitted.

In Step S211, distribution server 30A generates transaction data including the latest version information of a software product. Furthermore, distribution server 30A transmits the generated transaction data to another distribution server, i.e., distribution server 31A.

In Step S212, distribution server 31A generates transaction data including the latest version information of a software product. Furthermore, distribution server 31A transmits the generated transaction data to another distribution server, i.e., distribution server 30A.

In Step S213, distribution server 30A, etc., stores, into the distributed ledger, the transaction data generated or transmitted in Steps S211 and S212.

In Step S214, a software product is installed on node 20. Step S214 is the same as the process performed in Step S121 according to Embodiment 1.

In Step S215, a software product is installed on node 21. Step S215 is the same as the process performed in Step S122 according to Embodiment 1.

In Step S216, transaction data is generated that includes current version information indicating the version of the software product installed on node 20 in Step S214. Furthermore, distribution server 30A transmits the generated transaction data to another distribution server, i.e., distribution server 31A.

In Step S217, transaction data is generated that includes current version information indicating the version of the software product installed on node 21 in Step S215. Furthermore, distribution server 31A transmits the generated transaction data to another distribution server, i.e., distribution server 30A.

In Step S218, distribution server 30A, etc., stores, into the distributed ledger, the transaction data generated or transmitted in Steps S216 and S217.

After Step S218, terminal 40A refers to the distributed ledger included in distribution server 30A, etc., thus obtains version information including the latest version information and the current version information (Steps S101, S102), calculates a security level (Step S103), determines an authorized node (Step S104), then generates transaction data, and transmits the transaction data to the destination node (Steps S105 to S107).

Steps S221 to S224 are the same as Steps S131 to S134 according to Embodiment 2.

In this manner, using distribution server 30A, etc., and terminal 40A that include the functions of the control device, it is possible to minimize the decrease in the reliability of transaction data that is stored into a distributed ledger.

### Embodiment 5

The present exemplary embodiment will more specifically describe a control method, etc., in which the decrease in the reliability of transaction data that is stored into a distributed ledger is minimized. With the control method according to the present exemplary embodiment, instead of distribution server 30, etc., managing the version of the software product included in each of the plurality of nodes 20A, etc., the plurality of nodes 20A, etc., manage said version. This makes it possible to properly minimize the decrease in the reliability of the transaction data that is stored into a distributed ledger even if distribution server 30, etc., has operational malfunctions or vulnerabilities.

The system according to the present exemplary embodiment has a configuration that is substantially the same as the configuration of the system according to Embodiment 4 (refer to FIG. 18). A plurality of nodes according to the present exemplary embodiment are referred to as nodes 20A, 21A, 22A (also referred to as node 20A, etc.).

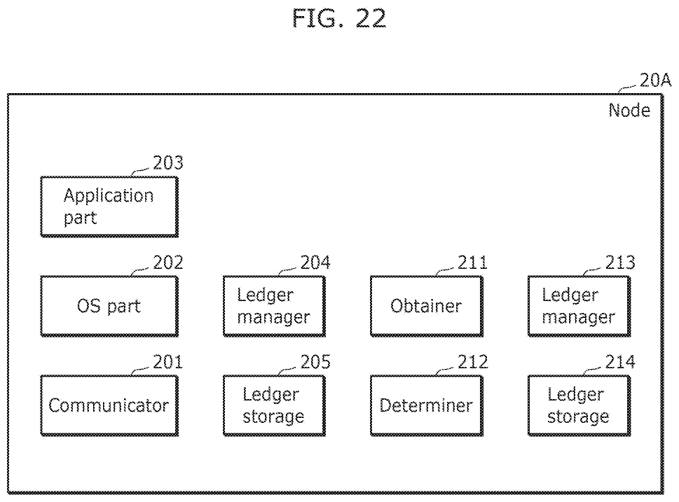

FIG. 22 is a block diagram schematically illustrating the functions of node 20A according to the present exemplary embodiment.

As illustrated in FIG. 22, node 20A includes communicator 201, OS part 202, application part 203, ledger manager 204, ledger storage 205, obtainer 211, determiner 212, ledger manager 213, and ledger storage 214 as function parts. Among the function parts included in node 20A, communicator 201, OS part 202, application part 203, ledger manager 204, and ledger storage 205 are substantially the same as those included in node 20 according to Embodiment 2. The distributed ledger stored in ledger storage 205 corresponds to the first distributed ledger. The functions parts included in node 20A may each be provided by a processor (for example, a CPU (not illustrated in the Drawings)) executing a predetermined program using memory (not illustrated in the Drawings).

Obtainer 211 represents greater details of obtainer 102 according to Embodiment 1. Obtainer 211 obtains the security level of each of the plurality of nodes 20A, etc. In the obtaining of the security level, obtainer 211 obtains version information indicating the version of a software product included in the own device and further obtains, from nodes included in the plurality of nodes 20A, etc., other than the own device, version information indicating the version of a software product included in each of said nodes. Obtainer 211 obtains the security level on the basis of the obtained version information, provides the obtained security level to ledger manager 213, and stores the obtained security level into ledger storage 214. Subsequently, obtainer 211 obtains the security level by reading the security level from ledger storage 214. The process of obtaining the security level by obtainer 211 on the basis of the version information is substantially the same as the process performed by obtainer 102A according to Embodiment 2 or obtainer 102B according to Embodiment 3.

Determiner 212 determines an authorized node from among the plurality of nodes 20A, etc. Determiner 212 preferentially determines a node having a higher security level among the plurality of nodes 20A, etc., as an authorized node. For example, in the determining of the authorized node, determiner 212 may determine a node having a security level greater than or equal to a threshold value among the plurality of nodes 20A, etc., as the authorized node. Furthermore, in the determining of the authorized node, determiner 212 may determine a randomly selected node having a security level greater than or equal to the threshold value among the plurality of nodes 20A, etc., as the authorized node.

Ledger manager 213 performs processes related to the transaction data to be stored into the distributed ledger stored in ledger storage 214. When ledger manager 213 obtains the version information from obtainer 211, ledger manager 213 generates transaction data including the obtained version information, and stores the generated transaction data into the distributed ledger. Furthermore, ledger manager 213 transmits and receives communication data via communicator 201 to and from ledger manager 213 included in another node among the plurality of nodes 20A, etc., and causes the distributed ledger included in the other node to store said transaction data.

Ledger storage 214 is storage (in other words, a storage device) in which the distributed ledger (corresponding to the third distributed ledger) is stored. The distributed ledger stored in ledger storage 214 is a distributed ledger on which the security level of each of the plurality of nodes 20A, etc., is managed. The distributed ledger stored in ledger storage 214 can store one or more items of transaction data, and the transaction data stored therein is managed in a tamper-proof manner using the features of a hash function and the like. Ledger storage 214 stores, into the distributed ledger, the transaction data provided from ledger manager 213.

One example of the distributed ledger included in ledger storage 214 is hashgraph. The hashgraph has a data structure in which events corresponding to transaction data (also referred to as event data) are connected and is managed in a tamper-proof manner using the features of a hash function and the like.

In the case where the distributed ledger included in ledger storage 214 is hashgraph, when ledger manager 213 obtains the version information from obtainer 211, ledger manager 213 generates event data including the obtained version information, and connects the generated event data to the hashgraph. Furthermore, ledger manager 213 transmits the generated event data to another node included in the plurality of nodes 20A, etc., and connects the generated event data to the hashgraph in the other node.

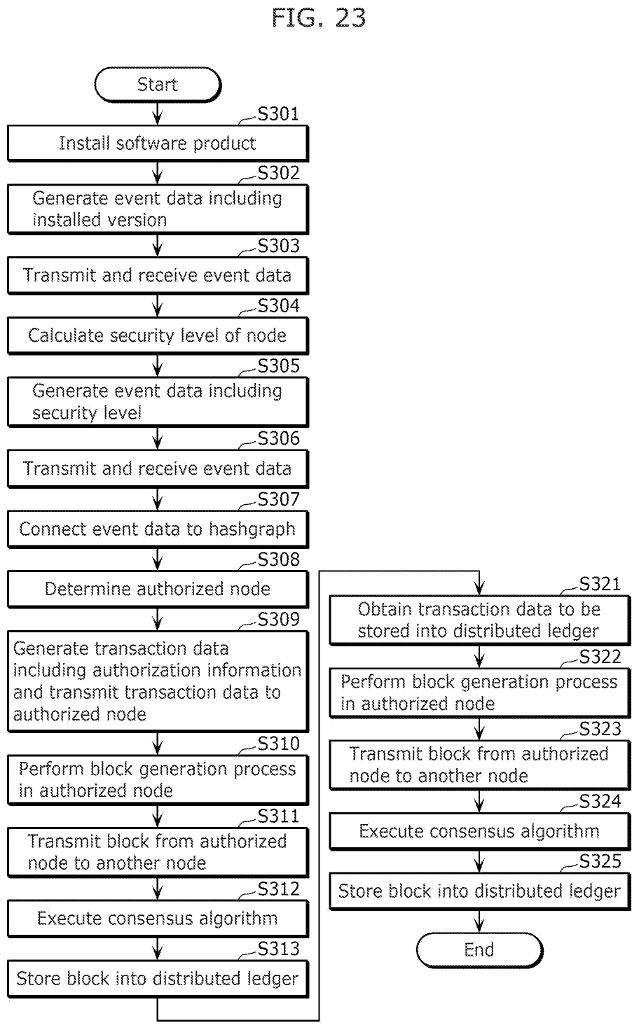

FIG. 23 is a flowchart illustrating processes performed by node 20A according to the present exemplary embodiment.

In Step S301, a software product is installed on node 20A. The installation of the software product is substantially the same as that performed in Step S121.

In Step S302, obtainer 211 generates event data including the version of the software product installed in Step S301.

In Step S303, obtainer 211 transmits, to another node included in the plurality of nodes 20A, etc., the event data generated in Step S302. Furthermore, obtainer 211 receives the event data transmitted from another node included in the plurality of nodes 20A, etc.

In Step S304, obtainer 211 calculates the security level of each of the plurality of nodes 20A, etc. The security level is calculated with reference to the version information included in the event data generated in Step S302 and the version information included in the event data received in Step S303.

In Step S305, obtainer 211 generates event data including the security level of each of the plurality of nodes 20A, etc., calculated in Step S304.

In Step S306, obtainer 211 transmits, to another node included in the plurality of nodes 20A, etc., the event data generated in Step S305. Furthermore, obtainer 211 receives the event data transmitted from another node included in the plurality of nodes 20A, etc.

In Step S307, ledger manager 213 connects, to the hashgraph included in ledger storage 214, the event data received by obtainer 211 in Step S306. This event data includes the event data generated in Step S302, the event data received in Step S303, the event data generated in Step S305, and the event data received in Step S306.

In Step S308, determiner 212 determines an authorized node from among the plurality of nodes 20A, etc., using the security level calculated in Step S304.

In Step S309, determiner 212 generates transaction data including authorization information indicating the authorized node that has been determined in Step S308, and provides the generated transaction data to ledger manager 204. Furthermore, determiner 212 transmits the generated transaction data to the authorized node.

In Step S310, ledger manager 204 included in the authorized node performs the block generation process related to the generation of a block including the transaction data generated in Step S309. In the block generation process, ledger manager 204 determines whether to generate a block including the transaction data generated in Step S309. The following will describe the case where ledger manager 204 has determined that the block is to be generated.

In Step S311, ledger manager 204 included in the authorized node transmits, to another node (specifically, nodes 21A, 22A) included in the plurality of nodes, the block generated in Step S310.

In Step S312, ledger manager 204 executes the consensus algorithm for the block generated in S310.

In Step S313, ledger manager 204 stores, into the distributed ledger, the block generated in Step S310.

In Step S321, node 20A obtains the transaction data to be stored into the distributed ledger. Node 20A obtains, as the transaction data, the transaction data generated and transmitted by terminal 40A.

In Step S322, ledger manager 204 included in the authorized node performs the block generation process related to the generation of a block including the transaction data obtained in Step S321. In the block generation process, ledger manager 204 determines whether to generate a block including the transaction data obtained in Step S321. The following will describe the case where ledger manager 204 has determined that the block is to be generated.

In Step S323, ledger manager 204 included in the authorized node transmits, to another node (specifically, nodes 21A, 22A) included in the plurality of nodes, the block generated in Step S322.

In Step S324, ledger manager 204 executes the consensus algorithm for the block generated in S322.

In Step S325, ledger manager 204 stores, into the distributed ledger, the block generated in Step S322.

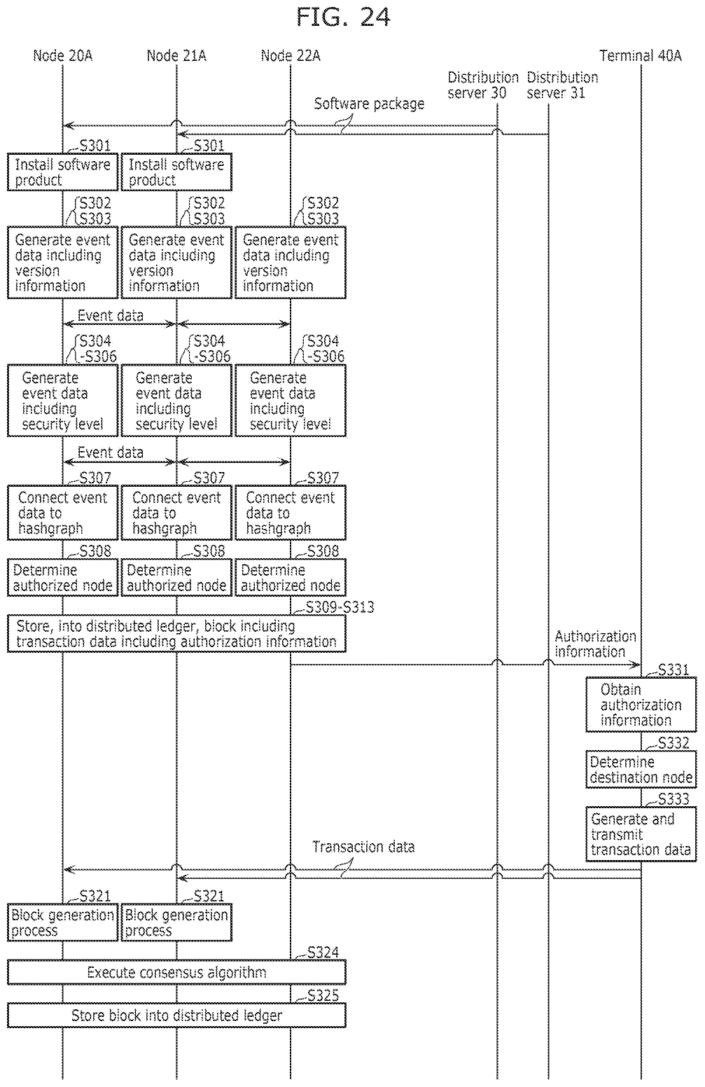

FIG. 24 is the first sequence chart illustrating the processes performed by system 1A according to the present exemplary embodiment. Note that in FIG. 24, processes that are the same as the processes illustrated in FIG. 23 are assigned the same reference signs, and detailed description of the processes may be omitted.

In Step S301, a software product is installed on each of nodes 20A, 21A.

Subsequently, each of nodes 20A, 21A generates: event data including version information indicating the version of the software product installed thereon; and event data including a security level, and connects the generated event data to the hashgraph (Steps S302 to S307). At this time, node 22A generates: event data including the current version information; and event data including the security level, and connects the event data to the hashgraph (Steps S302 to S307).

Furthermore, each of the plurality of nodes 20A, etc., refers to the hashgraph, determines an authorized node, generates transaction data including authorization information indicating the authorized node that has been determined, and stores, into the distributed ledger, a block including the generated transaction data (Steps S309 to S313). At this time, the authorized nodes determined by the plurality of nodes 20A, etc., may be different. In this case, an authorized node may be determined by a majority vote from among the authorized nodes determined by the plurality of nodes 20A, etc. The following will describe the case where nodes 20A, 21A have each been determined as the authorized node.

In Step S331, terminal 40A obtains the authorization information with reference to the distributed ledger held by node 20A, etc.

In Step S332, terminal 40A determines, as destination nodes, nodes 20A, 21A that are the authorized nodes indicated in the authorization information obtained in Step S331.

In Step S333, terminal 40A generates transaction data to be stored into the distributed ledger and transmits the transaction data to the destination nodes, i.e., nodes 20A, 21A.

In Steps S321 to S325, node 20A performs the block generation process and then stores the generated block into the distributed ledger.

Note that in the case where a node holding a distributed ledger is newly connected to the plurality of nodes 20A, etc., the node newly connected can establish hashgraph from the point in time of the connection and thus can participate in system 1A. Processes performed in this case will be described.

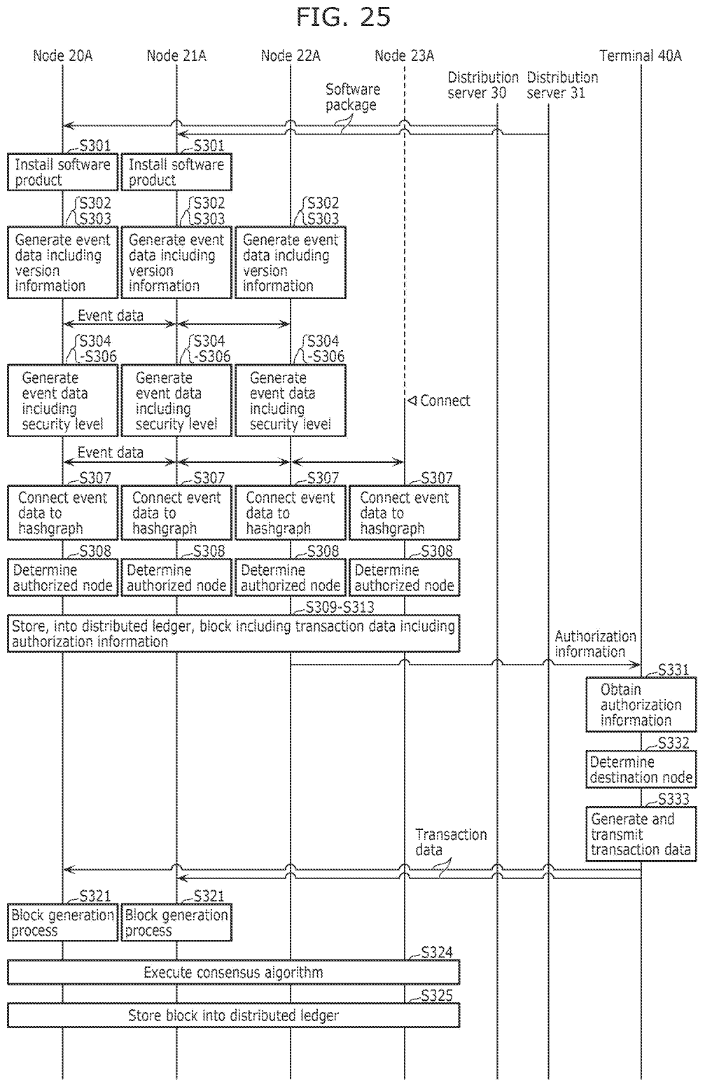

FIG. 25 is the second sequence chart illustrating the processes performed by system 1A according to Embodiment 5. FIG. 25 illustrates the processes performed by system 1A when new node 23A is added to the plurality of nodes 20A, etc.

In FIG. 25, it is assumed that node 23A is added while the plurality of nodes 20A, etc., generate event data including security levels.

In this case, node 23A is added to the destinations to which the event data is to be transmitted (Step S306), and thus node 23A may receive the transmitted event data.

Subsequently, node 23A performs the process of connecting the event data to the hashgraph (Step S307) and then performs processes that are substantially the same as the processes performed by node 20A, etc.

In this manner, even when a node is additionally connected, the added node can receive the event data and perform the processes as one of the plurality of nodes 20A, etc.

In this manner, node 20A, etc., and terminal 40A that include the functions of the control device manage the version of the software product included in each of the plurality of nodes 20A, etc., and thus it is possible to properly minimize the decrease in the reliability of transaction data that is stored into a distributed ledger.

### Additional Comments

Additional comments will be provided about the distributed ledgers according to the above embodiments and variations. A blockchain will be described below as one example of the distributed ledger, but the same applies to other distributed ledgers as well.

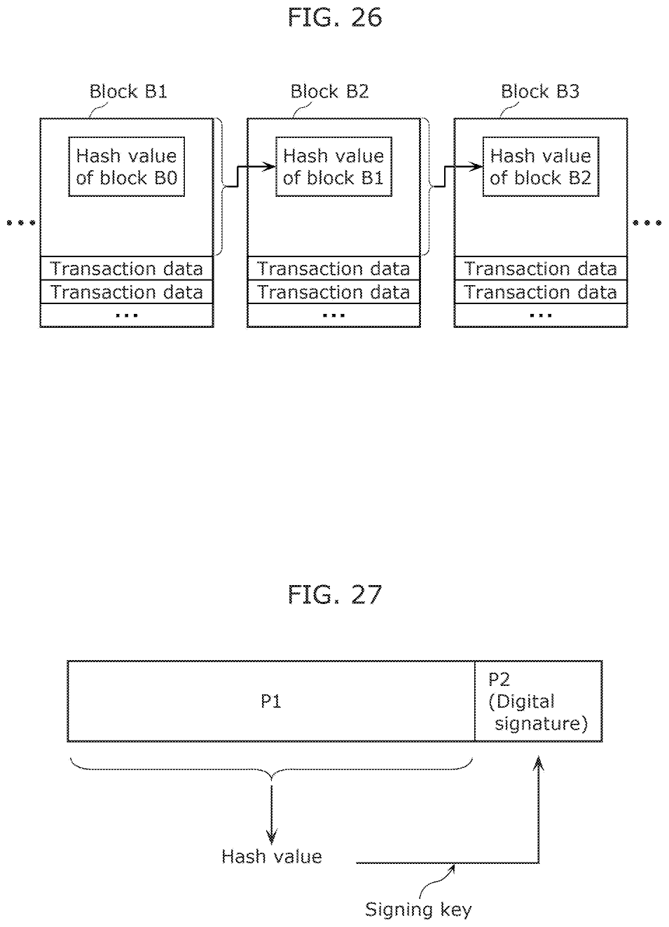

FIG. 26 is an explanatory diagram illustrating the data structure of a blockchain.

A blockchain is made up of blocks, each of which is a recording unit of the blockchain, linked together in the form of a chain. Each of the blocks includes a plurality of items of transaction data and a hash value of an immediately preceding block. Specifically, block B2 includes the hash value of previous block B1. Furthermore, a hash value calculated using the hash value of block B1 and the plurality of items of transaction data included in block B2 is included in block B3 as the hash value of block B2. In this manner, blocks are linked together in the form of a chain while including the content of previous blocks; thus, the recorded transaction data is effectively prevented from being tempered with.

If previous transaction data is changed, the hash value of the block becomes different from the original value, meaning that in order to make the block tampered with look correct, all the subsequent blocks need to be recreated, which is an extremely difficult task in practice. Using this feature, it is ensured that the blockchain is tamper-proof.

FIG. 27 is an explanatory diagram illustrating the data structure of transaction data.

The transaction data illustrated in FIG. 27 includes transaction body P1 and digital signature P2. Transaction body P1 is a data body included in said transaction data. Digital signature P2 is generated by signing the hash value of transaction body P1 with a signing key of a creator of said transaction data, more specifically, encrypting the hash value of transaction body P1 with a private key of the creator.

Because of including digital signature P2, the transaction data is practically impossible to tamper with. Thus, the transaction body is protected from tampering.

As described above, with the control methods according to the above embodiments, a node having a relatively high security level among the plurality of nodes is determined as a destination node for the transaction data, and thus the control device contributes to the transaction data being stored into the distributed ledger by the process performed by the node having a relatively high security level. If the transaction data is stored into the distributed ledger by the process performed by a node having a low security level, the reliability of the transaction data that is stored into the distributed ledger is decreased when said process has some flaws. In this manner, with the above-described control method, it is possible to minimize the decrease in the reliability of the transaction data that is stored into the distributed ledger.

Furthermore, the control device preferentially determines an authorized node among the plurality of nodes as the destination node; thus, it is possible to store the transaction data into the distributed ledger after the authorized node that has received the transaction data determines whether to store the transaction data into the distributed ledger. This makes information processing easier than when another node is determined as the destination node, meaning that it is possible to contribute to reduced network congestion and a reduction in power consumption as a result of a reduction in the amount of computer processing required, thereby providing improvements in computer-functionality. Additionally, with the above-described control method, it is possible to more easily minimize the decrease in the reliability of the transaction data that is stored into the distributed ledger.

Furthermore, the control device can easily set the security level using information indicating how old the version of the software product included in each of the plurality of nodes is and can determine the destination node using the security level that has been set in this manner. Thus, with the above-described control method, it is possible to more easily minimize the decrease in the reliability of the transaction data that is stored into the distributed ledger.

Furthermore, the control device can easily set the security level using the difference between the version of the software product included in each of the plurality of nodes and the latest version of said software product and can determine the destination node using the security level that has been set in this manner. Thus, with the above-described control method, it is possible to more easily minimize the decrease in the reliability of the transaction data that is stored into the distributed ledger.

Furthermore, the control device can easily set the security level on the basis of whether the version of the software product included in each of the plurality of nodes is a specific version and can determine the destination node using the security level that has been set in this manner. Thus, with the above-described control method, it is possible to more easily minimize the decrease in the reliability of the transaction data that is stored into the distributed ledger.

Furthermore, the control device can easily set the security level on the basis of whether the version set of the operating system and the application software product included in each of the plurality of nodes is a specific set and can determine the destination node using the security level that has been set in this manner. Thus, with the above-described control method, it is possible to more easily minimize the decrease in the reliability of the transaction data that is stored into the distributed ledger.

Furthermore, the control device can obtain the security level using the version information obtained with reference to the distributed ledger for software version management that is managed by the plurality of servers that distribute the software product, and can determine the destination node. Since the version information that is properly managed by the distributed ledger in a practically tamper-free manner is used, a more appropriate node can be determined as the destination node. Thus, with the above-described control method, it is possible to more properly minimize the decrease in the reliability of the transaction data that is stored into the distributed ledger.

Furthermore, the control device can obtain the security level using the version information obtained with reference to the distributed ledger for software version management that is managed by the plurality of nodes themselves, and can determine the destination node. Since the version information that is properly managed by the distributed ledger in a practically tamper-free manner is used, a more appropriate node can be determined as the destination node. Thus, with the above-described control method, it is possible to more properly minimize the decrease in the reliability of the transaction data that is stored into the distributed ledger.

Furthermore, the control device preferentially determines a node having a higher security level, specifically, a node having a security level greater than or equal to the threshold value, as the destination node. With this, it is possible to easily determine which node is to be determined as the destination node. Thus, with the above-described control method, it is possible to more easily minimize the decrease in the reliability of the transaction data that is stored into the distributed ledger.

Furthermore, the control device preferentially determines a node having a higher security level, specifically, a randomly selected node having a security level greater than or equal to the threshold value, as the destination node. This makes it possible to more easily determine which node is to be determined as the destination node while keeping specific nodes having relatively high security levels from being disproportionately determined as the destination nodes. Thus, with the above-described control method, it is possible to more easily minimize the decrease in the reliability of the transaction data that is stored into the distributed ledger.

Furthermore, the control device transmits the transaction data to the node determined as the destination node and having a relatively high security level. This allows the control device to easily perform control such that the transaction data is stored into the distributed ledger by the process performed by the node having a relatively high security level. Thus, with the above-described control method, it is possible to more easily minimize the decrease in the reliability of the transaction data that is stored into the distributed ledger.

Note that in the above exemplary embodiments or variations, each of the structural elements may be configured in the form of an exclusive hardware product, or may be realized by executing a software program suitable for the structural element. Each of the structural elements may be realized by means of a program executing unit, such as a CPU or a processor, reading and executing the software program recorded on a recording medium such as a hard disk or semiconductor memory. Here, the software program for realizing the server, etc., according to each of the above exemplary embodiments is a program described below.

Specifically, this program causes a computer to execute a control method that is performed by a control device in a distributed ledger system including a plurality of nodes each holding a distributed ledger, and includes: obtaining transaction data to be stored into the distributed ledger; obtaining a security level of each of the plurality of nodes; and determining, preferentially, a node having a higher security level among the plurality of nodes as a destination node for the transaction data.

The control device, etc., according to one or more aspects has been described thus far based on the exemplary embodiments, but the present disclosure is not limited to these exemplary embodiments. Various modifications to the present exemplary embodiments and forms configured by combining structural elements in different exemplary embodiments that can be conceived by those skilled in the art may be included within the scope of one or more aspects as long as these do not depart from the essence of the present disclosure.

### INDUSTRIAL APPLICABILITY

The present disclosure can be used in a distributed ledger system.

1. A control method that is performed by a device in a distributed ledger system including a plurality of nodes each holding a distributed ledger, the control method comprising:
obtaining transaction data to be stored into the distributed ledger;
obtaining a security level of each of the plurality of nodes; and
determining, preferentially, a node having a higher security level among the plurality of nodes as a destination node for the transaction data.

2. The control method according to claim 1, wherein
the determining includes:
determining, from among the plurality of nodes, an authorized node that is authorized to determine whether to store the transaction data into the distributed ledger; and
determining, preferentially, the authorized node determined, as the destination node.

3. The control method according to claim 1, further comprising:
obtaining version information indicating a version of a software product included in each of the plurality of nodes, wherein
in the obtaining of the security level,
the security level is obtained by setting a security level of a node including a newer version of the software product to a higher security level based on the version information obtained.

4. The control method according to claim 3, wherein
in the obtaining of the security level,
the security level is obtained by setting a security level of a node having a smaller version difference among the plurality of nodes to a higher security level based on the version information obtained, the smaller version difference indicating that a difference between the version of the software product included in the node and a latest version available for the node is smaller.

5. The control method according to claim 1, further comprising:
obtaining version information indicating a version of a software product included in each of the plurality of nodes, wherein
in the obtaining of the security level,
the security level is obtained by setting a security level of a node including a specific version of the software product to a lower security level based on the version information obtained.

6. The control method according to claim 3, wherein
the plurality of nodes include, as the software product, two software products that are an operating system and driver software,
in the obtaining of the version information,
first version information indicating a version of the operating system and second version information indicating a version of the driver software are obtained, and
in the obtaining of the security level,
the security level is obtained by setting a security level of a node including a specific set of the version of the operating system and the version of the driver software to a lower security level based on the first version information and the second version information.

7. The control method according to claim 3, wherein
the distributed ledger is a first distributed ledger,
the distributed ledger system further includes a plurality of servers each holding a second distributed ledger and including a function for distributing the software product that is included in each of the plurality of nodes, the second distributed ledger being a distributed ledger in which the version of the software product distributed to each of the plurality of nodes is managed, and
in the obtaining of the version information,
the version information is obtained by referring to the second distributed ledger managed by each of the plurality of servers.

8. The control method according to claim 1, wherein
the distributed ledger is a first distributed ledger,
each of the plurality of nodes includes a third distributed ledger in which the security level of each of the plurality of nodes is managed, and
in the obtaining of the security level,
the security level is obtained by reading the security level from the third distributed ledger.

9. The control method according to claim 1, wherein
in the determining,
among the plurality of nodes, a node having a security level greater than or equal to a threshold value is determined as the destination node.

10. The control method according to claim 1, wherein
in the determining,
among the plurality of nodes, a randomly selected node having a security level greater than or equal to a threshold value is determined as the destination node.

11. The control method according to claim 1, further comprising:
transmitting, to the destination node determined, the transaction data obtained.

12. A device in a distributed ledger system including a plurality of nodes each holding a distributed ledger, the device comprising:
an obtainer that obtains transaction data to be stored into the distributed ledger and obtains a security level of each of the plurality of nodes; and
a determiner that determines, preferentially, a node having a higher security level among the plurality of nodes as a destination node for the transaction data.

13. A non-transitory computer-readable recording medium having recorded thereon a program for causing a computer to execute the control method according to claim 1.
